(19) United States
(12) Patent Application Publication
(10) Pub. No.: US 2016/0125030 A1
(43) Pub. Date: May 5, 2016

(54) SYSTEM, METHOD AND RECORDING MEDIUM

(71) Applicant: FUJITSU LIMITED, Kawasaki-shi (JP)

(72) Inventors: Tsuyoshi ADACHI, Kobe (JP); Daisuke NINOMIYA, Kobe (JP)

(73) Assignee: FUJITSU LIMITED, Kawasaki-shi (JP)

(21) Appl. No.: 14/925,735

(22) Filed: Oct. 28, 2015

(30) Foreign Application Priority Data
Oct. 31, 2014 (JP) 2014-223686

(51) Int. Cl. G06F 17/30

(52) U.S. Cl. CPC G06F 17/30463; G06F 17/30501

(57) ABSTRACT

A system includes a primary control device configured to control access to a first database and a secondary control device which is a standby device of the primary control device and is configured to control access to a second database. The secondary control device is configured to: receive first access prescribing information which prescribes processing for accessing the first database, and an inquiry statement to the first database from the primary control device; store the received first access prescribing information as a second access prescribing information and the inquiry statement in a first memory of the secondary control device; and erase the second access prescribing information, which is stored in the first memory and is used for the secondary control device to access the second database, when a notification of releasing a connection is received from the primary control device, the connection being used for accessing the first database.

### CROSS-REFERENCE TO RELATED APPLICATION

This application is based upon and claims the benefit of priority of the prior Japanese Patent Application No. 2014-223686, filed on Oct. 31, 2014, the entire contents of which are incorporated herein by reference.

### FIELD

The embodiments discussed herein relate to a technique for controlling a multiplex database system.

### BACKGROUND

A database management system, for example, receives an access request in an SQL statement format from an application module, creates an access plan that prescribes the processing of the access operation in response to the received access request, and the executes the created access plan.

Moreover, the database management system omits recreating the access plan by holding the access plan in a cache region while the connection with the application module is still established to shorten the response time period with regard to the access request.

Meanwhile, a multiplex database system provided with a plurality of control devices for assuring availability is known. In a multiplex database system, a standby subsystem control device inherits processing as a new primary system control device when the primary system control device is stopped. In order to improve performance when inheriting the processing as the new primary system control device, the amount of data previously stored in the subsystem control device may become very large.

Japanese Laid-Open Patent Publication No. 2007-233543 is known as an example of prior art.

### SUMMARY

According to an aspect of the invention, a system includes a primary control device configured to control access to a first database and a secondary control device which is a standby device of the primary control device and is configured to control access to a second database. The secondary control device is configured to: receive first access prescribing information which prescribes processing for accessing the first database, and an inquiry statement to the first database from the primary control device; store the received first access prescribing information as a second access prescribing information and the inquiry statement in a first memory of the secondary control device; and erase the second access prescribing information, which is stored in the first memory and is used for the secondary control device to access the second database, when a notification of releasing a connection is received from the primary control device, the connection being used for accessing the first database.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a first example of a network configuration;

FIG. 2 illustrates a second example of the network configuration;

FIG. 3 illustrates an example of a sequence according to a first embodiment;

FIG. 4 illustrates an example of a sequence according to the first embodiment;

FIG. 5 illustrates an example of a sequence according to the first embodiment;

FIG. 6 illustrates a module configuration example of a database management system in a primary system node;

FIG. 7 illustrates a table configuration example of a cache region;

FIG. 8 illustrates a module configuration example of a database management system in a subsystem node;

FIG. 9 illustrates an example of a saving region according to the first embodiment;

FIG. 10 illustrates a main processing flow of a primary system processing unit;

FIG. 11 illustrates a main processing flow of a primary system processing unit;

FIG. 12 illustrates a connection processing flow;

FIG. 13 illustrates an extraction processing (A) flow;

FIG. 14 illustrates a saving processing flow;

FIG. 15 illustrates a disconnection processing (A) flow;

FIG. 16 illustrates a main processing flow of a subsystem processing unit;

FIG. 17 illustrates a storage processing (A) flow;

FIG. 18 illustrates an erasing processing (A) flow;

FIG. 19 illustrates a module configuration example of a database management system in a new primary system node;

FIG. 20 illustrates an extraction processing (B) flow;

FIG. 21 illustrates an example of a sequence according to a second embodiment;

FIG. 22 illustrates an example of a sequence according to the second embodiment;

FIG. 23 illustrates an example of a saving region to the second embodiment;

FIG. 24 illustrates an extraction processing (C) flow;

FIG. 25 illustrates a disconnection processing (B) flow;

FIG. 26 illustrates a storing processing (B) flow;

FIG. 27 illustrates an erasing processing (B) flow;

FIG. 28 illustrates an adjustment processing flow;

FIG. 29 illustrates an example of a sequence according to a fourth embodiment;

FIG. 30 illustrates an example of a sequence according to the fourth embodiment;

FIG. 31 illustrates an example of a saving region according to the fourth embodiment;

FIG. 32 illustrates a storing processing (C) flow;

FIG. 33 illustrates an erasing processing (C) flow;

FIG. 34 illustrates a statistics processing flow;

FIG. 35 illustrates a waiting processing flow; and

FIG. 36 is a functional block diagram of a computer.

### DESCRIPTION OF EMBODIMENTS

An object of one aspect of the embodiments discussed herein is to avert the depletion of storage regions for storing access prescribing information in a subsystem control device.

### First Embodiment

An example of releasing a connection with a primary system node 103 and erasing as a batch the access plans associated with the connection in a subsystem node 107 is discussed in the present embodiment.

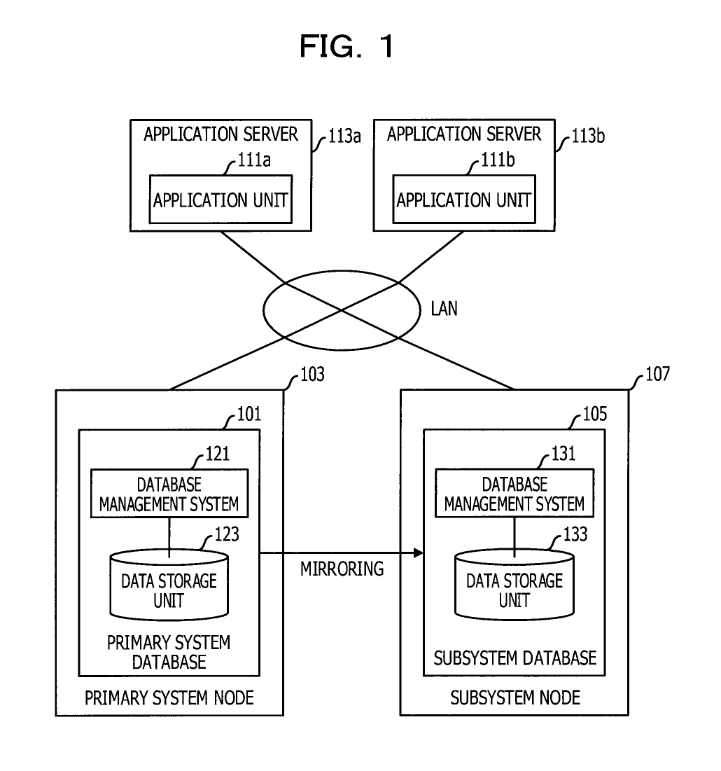

FIG. 1 illustrates a first example of a network configuration. A database system in the present embodiment is multiplexed by mirroring. Accordingly, the exemplified database system may be called a multiplex database system. The database system includes the primary system node 103 that operates a primary system database 101 and the subsystem node 107 that operates a subsystem database 105. The primary system node 103 and the subsystem node 107 are connected over a local area network (LAN).

The primary system database 101 is an active database. The subsystem database 105 is a standby database. When an abnormality occurs in the primary system node 103, the subsystem database 105 inherits the working state of the primary system database 101 and thus operations as a database system are continued. That is, the subsystem database 105 illustrated in FIG. 1 becomes a new primary system database due to the switching of the nodes.

An application server 113a having an application unit 111a and an application server 113b having an application unit 111b are connected through the LAN. The application unit 111a and the application unit 111b are examples of program modules for using databases. The application unit 111a and the application unit 111b may be called work application units when acting as applications for operating a database during work by a user.

The primary system database 101 has a database management system 121 and a data storage unit 123. Data is transferred between the database management system 121 and the data storage unit 123 through an internal bus for example. The subsystem database 105 has a database management system 131 and a data storage unit 133. Data is transferred between the database management system 131 and the data storage unit 133 through an internal bus for example. In this example, the primary system database 101 and the subsystem database 105 are relational type databases.

The database management system 121 manages the data stored in the data storage unit 123 and receives access requests to the database and performs processing in response to the access requests.

The data stored in the data storage unit 123 may be shared data. The data stored in the data storage unit 123 includes, for example, data for defining a structure of a table and actual data in the table.

The database management system 131 has the same processing capabilities as the database management system 121 and fulfills the role of replacing the database management system 121. Moreover, the database management system 131 performs processing while in standby. The data stored in the data storage unit 133 is synchronized with the data stored in the data storage unit 123. That is, in the example in FIG. 1, the data storage unit in the database system is multiplexed with the data storage unit 123 and the data storage unit 133.

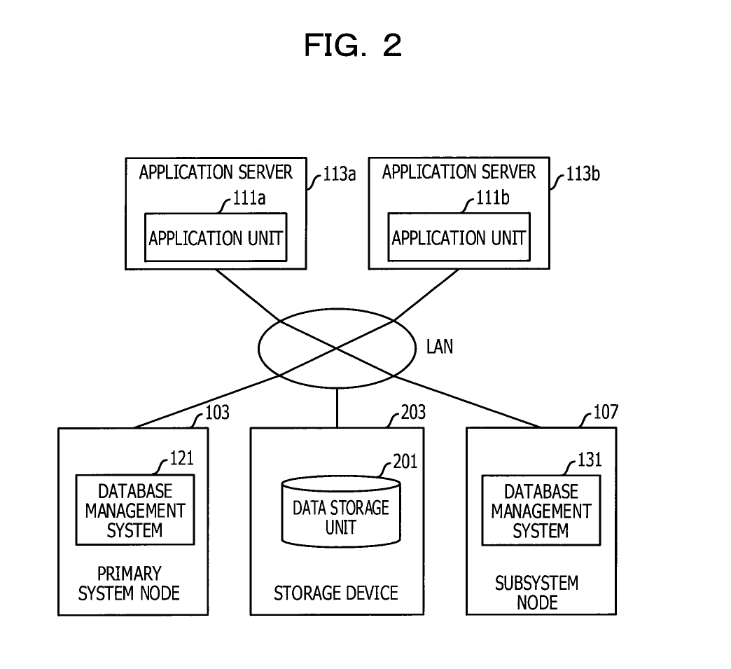

FIG. 2 illustrates a second example of the network configuration. The database system includes the primary system node 103 that operates the database management system 121 and the subsystem node 107 that operates the database management system 131. The primary system node 103 and the subsystem node 107 are connected over a local area network (LAN).

The database system further has a storage device 203 that has the data storage unit 201. The storage device 203 is connected with the primary system node 103 and the subsystem node 107 over a LAN. The storage device 203 acts as the active database in the same way as the primary system database 101 in FIG. 1 due to the database management system 121 and the data storage unit 201. When an abnormality occurs in the primary system node 103, the database management system 131 inherits the processing in place of the database management system 121. The subsystem database 105 acts as the standby database in the same way as in FIG. 1 due to the database management system 131 and the data storage unit 201.

In this way, database management system 121 and the database management system 131 in the database management system in the example in FIG. 2 are multiplexed, but the data storage unit 201 is not multiplexed.

The application server 113a having the application unit 111a and the application server 113b having the application unit 111b are connected through the LAN in the same way as in FIG. 1.

While FIGS. 1 and 2 illustrate examples of multiplex databases, the present embodiment may be applicable to multiplexing with three or more databases.

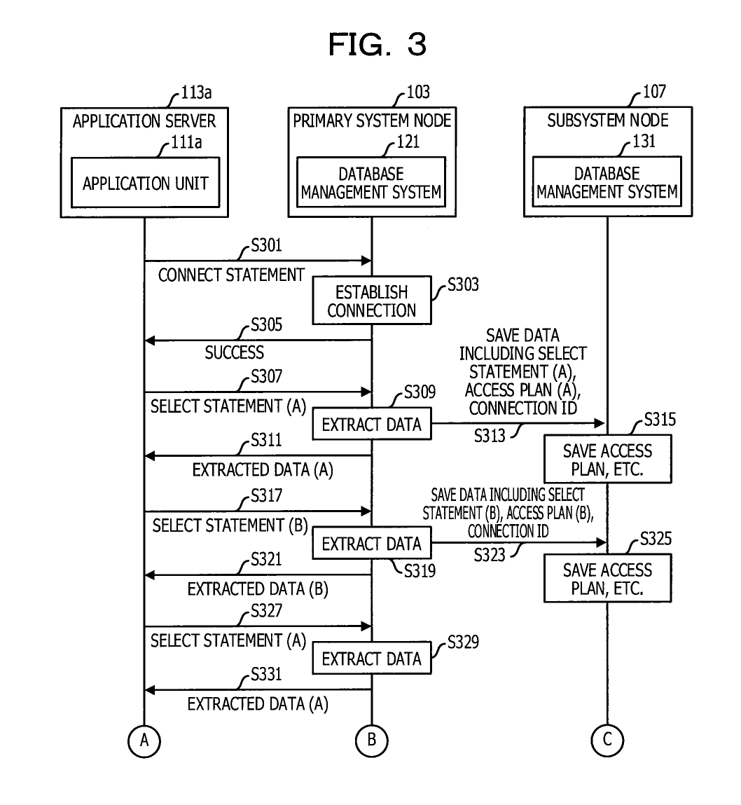

An example of a sequence will be explained next. FIG. 3 illustrates an example of a sequence according to the first embodiment. In this example, it is assumed that a multiplex database system having the primary system node 103 and the subsystem node 107 is used during work by the application unit 111a in the application server 113a.

An access request from the application unit 111a of the application server 113a to the database management system 121 of the primary system node 103 and an access request from the application unit 111a of the application server 113a to the database management system 131 of the primary system node 107 are written for example in the format of a SQL statement. Access to the database may be requested using an inquiry statement using a database language other than SQL. The sequence in this example is based on SQL specifications.

The application unit 111a of the application server 113a first transmits a CONNECT statement to the database management system 121 of the primary system node 103 (S301). A CONNECT statement is an SQL statement for requesting a connection to the database system.

Upon receiving the CONNECT statement, the database management system 121 of the primary system node 103 establishes a connection with the application unit 111a of the application server 113a that is the source of the request (S303). At this time, a connection ID for identifying the established connection is assigned. The database management system 121 of the primary system node 103 then returns a code indicating “success” to the application unit 111a of the application server 113a (S305).

The application unit 111a of the application server 113a first transmits a SELECT statement (A) to the database management system 121 of the primary system node 103 while the connection is established (S307). The SELECT statement (A) assumes the connection established in S303. In this example, the SELECT statement (A) signifies a SELECT statement of the type A.

The database management system 121 of the primary system node 103 receives the SELECT statement (A) and extracts data in accordance with the SELECT statement (A) (S309). An access plan (A) based on the SELECT statement (A) is created at this time and the created access plan (A) is executed.

An access plan is information for prescribing the execution contents of processing for accessing the data (e.g., a table) managed by the database. The access plan defines the contents and order of computations for meeting the request according to the SQL statement. The computations may include extracting or sorting data using, for example, a table scan, an index scan, or a record ID.

As a result of executing the created access plan (A), the desired data is extracted from a designated record included in, for example, a designated table. The database management system 121 of the primary system node 103 temporarily stores the created access plan (A) in a cache region inside the database management system 121 of the primary system node 103. The database management system 121 of the primary system node 103 then returns the extracted data (A) to the application unit 111a of the application server 113a (S311). In this example, the data (A) signifies the data extracted based on the SELECT statement (A).

During the extraction of the data in S309, the database management system 121 of the primary system node 103 creates saving data including the SELECT statement (A), the access plan (A), and the connection ID assigned in S303 and transmits the created saving data to the database management system 131 of the subsystem node 107 (S313). The connection ID added to the saving data at this time specifies the connection assumed in the SELECT statement (A).

The database management system 131 of the subsystem node 107 receives the saving data and saves the access plan included in the saving data and the data pertaining to the access plan (S315). The access plan created in this way by the database management system 121 of the primary system node 103 and the data pertaining to the access plan in the present embodiment are transmitted to the database management system 131 of the subsystem node 107 and saved in the database management system 131 of the subsystem node 107.

The application unit 111a of the application server 113a then transmits a SELECT statement (B) as an access request for continuing the SELECT statement (A) to the database management system 121 of the primary system node 103 (S317). The SELECT statement (B) assumes the connection established in S303. In this example, the SELECT statement (B) signifies a SELECT statement of a type B that is different from the type A.

The database management system 121 of the primary system node 103 receives the SELECT statement (B) and extracts data in accordance with the SELECT statement (B) (S319). An access plan (B) based on the SELECT statement (B) is created at this time and the created access plan (B) is executed. As a result, the desired data is extracted from the designated record included in, for example, the designated table. The database management system 121 of the primary system node 103 temporarily stores the created access plan (B) in a cache region inside the database management system 121 of the primary system node 103. The database management system 121 of the primary system node 103 then returns extracted data (B) to the application unit 111a of the application server 113a (S321). In this example, the data (B) signifies the data extracted based on the SELECT statement (B).

During the extraction of the data in S319, the database management system 121 of the primary system node 103 creates the saving data including the SELECT statement (B), the access plan (B), and the connection ID assigned in S303 and transmits the created saving data to the database management system 131 of the subsystem node 107 (S323). The connection ID added to the saving data at this time specifies the connection assumed in the SELECT statement (B).

The database management system 131 of the subsystem node 107 receives the saving data and saves the access plan included in the saving data and the data pertaining to the access plan (S325). The access plan (B) is also saved in addition to the abovementioned access plan (A). In this way, the database management system 121 of the primary system node 103 creates an access plan with regard to a new SQL statement and transmits the created access plan to the database management system 131 of the subsystem node 107. The database management system 131 of the subsystem node 107 accumulates the received access plans.

The following discusses a sequence when the same SQL statement is received again. The application unit 111a of the application server 113a transmits the SELECT statement (A) again as an access request for continuing the SELECT statement (B) to the database management system 121 of the primary system node 103 (S327). The SELECT statement (A) transmitted in S327 is the same as the SELECT statement (A) transmitted in S307. The retransmitted SELECT statement (A) assumes the connection established in S303.

The database management system 121 of the primary system node 103 receives the SELECT statement (A) and extracts data in accordance with the SELECT statement (A) (S329). The access plan (A) created in S309 is read from the cache region and the read access plan (A) is executed. That is, processing to create the access plan (A) based on the SELECT statement is omitted. The desired data is then extracted from the designated record included in, for example, the designated table. The database management system 121 of the primary system node 103 then returns the extracted data (A) to the application unit 111a of the application server 113a (S331).

In this example, the sequence between S309 and S329 illustrates a situation in which the data (A) extracted in S309 is extracted again in S329 assuming that the actual data in the database has not been updated. If the actual data in the database has been updated, different data may be extracted even if the same access plan is executed.

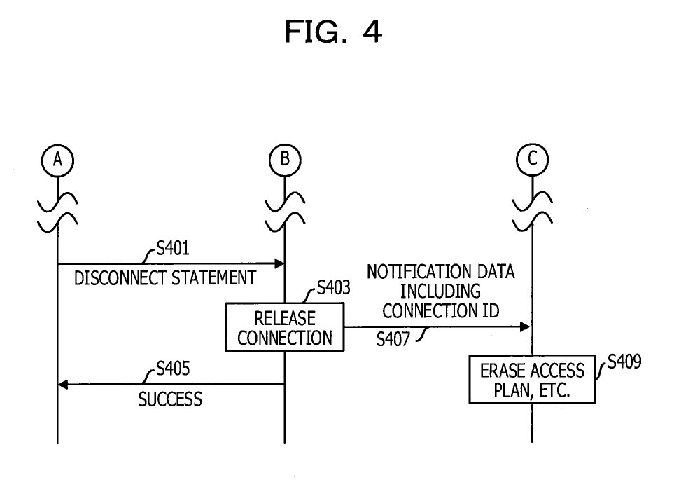

The sequence is continued in FIG. 4 through terminals A, B, and C. The application unit 111a of the application server 113a transmits a DISCONNECT statement to the database management system 121 of the primary system node 103 (S401) when the series of accesses assuming the connection established in S303 is completed. A DISCONNECT statement is an SQL statement for requesting a disconnection of the connection to the database system.

Upon receiving the DISCONNECT statement, the database management system 121 of the primary system node 103 releases the connection with the application unit 111a of the application server 113a that is the source of the request (S403). At this time, the access plan based on the received SQL statement assuming the released connection is erased from the cache region.

The database management system 121 of the primary system node 103 then returns a code indicating “success” to the application unit 111a of the application server 113a (S405).

The database management system 121 of the primary system node 103 transmits notification data including a connection ID that specifies the released connection to the database management system 131 of the subsystem node 107 according to the release of the connection illustrated in S403 (S407).

The database management system 131 of the subsystem node 107 receives the notification data and searches for the access plan associated with the connection ID included in the notification data among the access plans saved by the database management system 131. The database management system 131 of the subsystem node 107 erases the found access plan and the data pertaining to the access plan (S409).

In the present embodiment, the same access plan saved in the database management system 131 of the subsystem node 107 is erased at the timing in which the access plan in the cache region inside the database management system 121 of the primary system node 103 is erased. Therefore, a unilaterally continuing increase in the accumulated amount of access plans in the database management system 131 of the subsystem node 107 is suppressed.

It is assumed in FIG. 4 that the nodes are not switched until the release of the connection. The following is a sequence discussing a case in which the nodes are switched before the release of the connection.

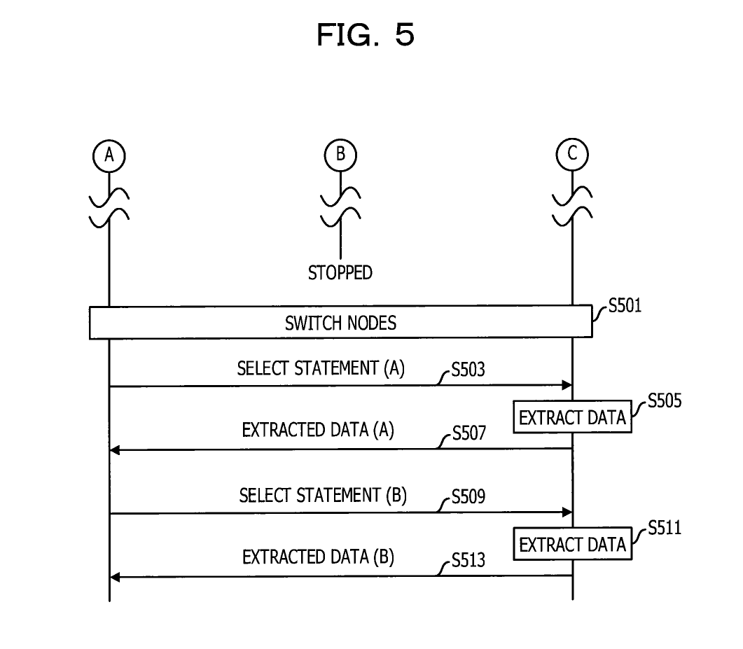

FIG. 5 illustrates a sequence continuing from FIG. 3 through the terminals A, B, and C. When the database management system 121 of the primary system node 103 is stopped, the switching of the nodes is performed (S501). For example, when no response is received from the database management system 121 of the primary system node 103 during a prescribed time period with regard to an access request from the application unit 111a of the application server 113a to the database management system 121 of the primary system node 103, the application unit 111a of the application server 113a determines that the database management system 121 of the primary system node 103 has stopped. The application unit 111a of the application server 113a then transmits a CONNECT statement to the database management system 131 of the subsystem node 107 and a new connection between the application unit 111a of the application server 113a and the database management system 131 of the subsystem node 107 is established. The subsystem node 107 becomes a new primary system node when the nodes are switched. In the example in FIG. 1, the subsystem database 105 in the subsystem node 107 becomes a new primary system database. That is, the new primary system database that operates in the new primary system node is realized by the database management system 131 and the data storage unit 133 illustrated in FIG. 1. The database management system 131 takes over the processing in the database management system 121.

After switching the nodes, the application unit 111a of the application server 113a is assumed to retransmit the SELECT statement (A) to the database management system 131 of the new primary system node (S503). The SELECT statement (A) transmitted in S503 is the same as the SELECT statement (A) transmitted in S307 and S327 in FIG. 3.

The database management system 131 of the new primary system node receives the SELECT statement (A) and extracts data in accordance with the SELECT statement (A) (S505). The access plan (A) saved in S315 in FIG. 3 is executed at this time. That is, processing to create the access plan (A) based on the SELECT statement is omitted. The desired data is then extracted from the designated records included in, for example, a designated table. The database management system 131 of the new primary system node returns the extracted data (A) to the application unit 111a of the application server 113a (S507).

In this example, the sequence between S309 and S505 illustrates a situation in which the data (A) extracted in S309 and S329 is extracted again in S505 assuming that the actual data in the database has not been updated.

The sequence for the SELECT statement (B) is the same as that of the SELECT statement (A). For example, the application unit 111a of the application server 113a then transmits the SELECT statement (B) as an access request for continuing the SELECT statement (A) to the database management system 121 of the new primary system node (S509). The SELECT statement (B) transmitted in S509 is the same as the SELECT statement (B) transmitted in S317 in FIG. 3.

The database management system 131 of the new primary system node receives the SELECT statement (B) and extracts data in accordance with the SELECT statement (B) (S511). The access plan (B) saved in S325 in FIG. 3 is executed at this time. That is, processing to create the access plan (B) based on the SELECT statement (B) is omitted. The desired data is then extracted from the designated record included in, for example, the designated table. The database management system 131 of the new primary system node returns the extracted data (B) to the application unit 111a of the application server 113a (S513).

In this way, the processing for creating the access plan after switching the nodes is omitted if the access plan is previously saved in the database management system 131 of the subsystem node 107, and the processing is shortened.

In the sequence examples illustrated in FIGS. 3 and 5, a SELECT statement is illustrated as the example of the access request assumed by the connection, but the access request assumed by the connection may use another SQL statement such as an INSERT statement, a DELETE statement, or an UPDATE statement. The access plan and the data pertaining to the access plan are processing in the same way in the INSERT statement, the DELETE statement, or the UPDATE statement as in the SELECT statement.

That is, when a new INSERT statement is received by the database management system 121 of the primary system node 103, the database management system 121 of the primary system node 103 creates an access plan based on the received INSERT statement and inserts a record in the table by executing the created access plan. The database management system 121 of the primary system node 103 then transmits the saving data including the INSERT statement, the access plan, and the connection ID specifying the assumed connection to the database management system 131 of the subsystem node 107. The database management system 131 of the subsystem node 107 saves the access plan included in the saving data and the data pertaining to the access plan.

Similarly, when a new DELETE statement is received by the database management system 121 of the primary system node 103, the database management system 121 of the primary system node 103 creates an access plan based on the received DELETE statement and erases a record in the table by executing the created access plan. The database management system 121 of the primary system node 103 then transmits the saving data including the DELETE statement, the access plan, and the connection ID specifying the assumed connection to the database management system 131 of the subsystem node 107. The database management system 131 of the subsystem node 107 saves the access plan included in the saving data and the data pertaining to the access plan.

Similarly, when a new UPDATE statement is received by the database management system 121 of the primary system node 103, the database management system 121 of the primary system node 103 creates an access plan based on the received UPDATE statement and updates a record in the table by executing the created access plan. The database management system 121 of the primary system node 103 then transmits the saving data including the UPDATE statement, the access plan, and the connection ID specifying the assumed connection to the database management system 131 of the subsystem node 107. The database management system 131 of the subsystem node 107 saves the access plan included in the saving data and the data pertaining to the access plan.

The database management system 131 of the subsystem node 107 erases the access plan based on the INSERT statement, the access plan based on the DELETE statement, and the access plan based on the UPDATE statement in the same way the access plan based on the SELECT statement is erased.

Similar to the database management system 131 of the new primary system node using the previously saved access plan upon receiving the SELECT statement after the switching of the nodes, the database management system 131 uses the previously saved access plan upon receiving the INSERT statement, the DELETE statement, or the UPDATE statement.

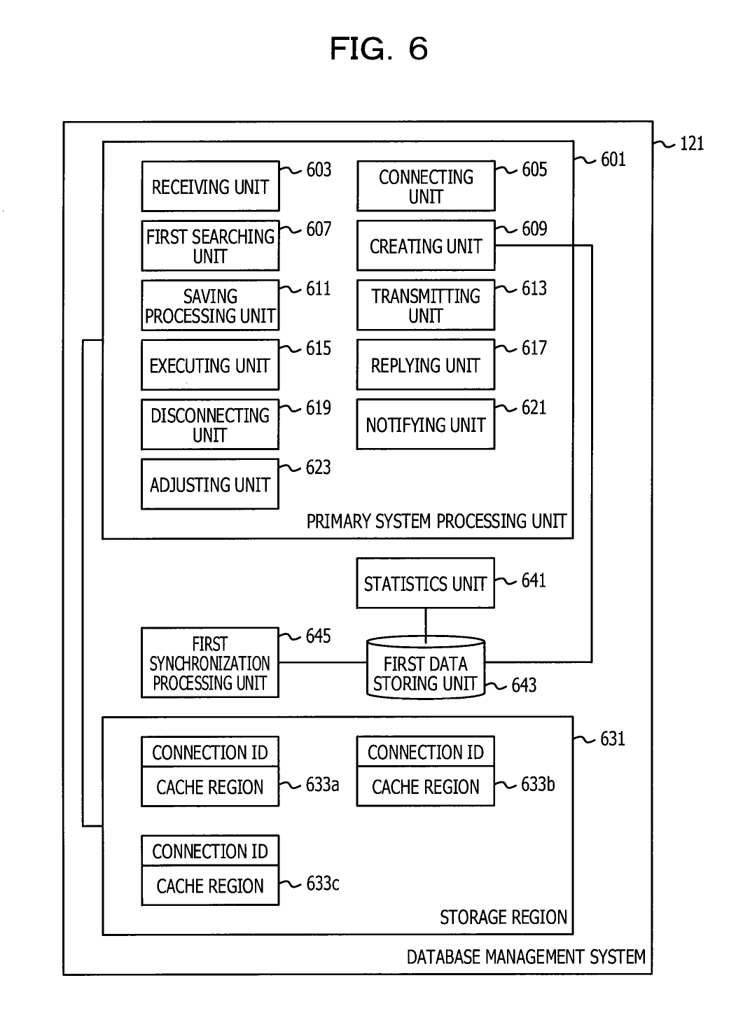

Next, a module configuration of the database management system 121 in the primary system node 103 will be explained. FIG. 6 illustrates a module configuration example of the database management system 121 in the primary system node 103. The database management system 121 has a primary system processing unit 601. The primary system processing unit 601 receives the SQL statement and performs processing in accordance with the SQL statement as an operating system. The primary system processing unit 601 has a receiving unit 603, a connecting unit 605, a first searching unit 607, a creating unit 609, a saving processing unit 611, a transmitting unit, an executing unit 615, a replying unit 617, a disconnecting unit 619, a notifying unit 621, and an adjusting unit 623.

The receiving unit 603 receives an SQL statement from a program module (e.g., the application unit 111a of the application server 113a) that uses the database. The connecting unit 605 performs connection processing to establish a connection with the program module that is the source of a CONNECT statement. The first searching unit 607 searches for an access plan in a cache region 633. The creating unit 609 creates an access plan based on the SQL statement. The saving processing unit 611 saves the created access plan in the cache region 633. The transmitting unit 613 transmits data to the database management system 131 of the subsystem node 107. The executing unit 615 executes the access plan. The replying unit 617 transmits the results of the execution of the access plan to the source of the SQL statement. The disconnecting unit 619 performs disconnection processing to release a connection with the program module that is the source of a DISCONNECT statement. The notifying unit 621 transmits notification data to the database management system 131 of the subsystem node 107. The adjusting unit 623 adjusts the available capacity of a storage region 631.

The database management system 121 has the storage region 631. The storage region 631 is provided in a main memory or a cache memory of the primary system node 103 for example. The storage region 631 is provided with the cache region 633. In this example, cache regions 633a to 633c are provided. The cache region 633 is provided for each connection and is associated with a connection ID. In this example, a header section including the connection ID is added to the cache region 633.

The database management system 121 has a statistics unit 641, a first data storing unit 643, and a first synchronization processing unit 645. The statistics unit 641 creates statistics data (e.g., number of pages in a table, number of records in a table, or number of key values in an index, etc.) based on the utilization conditions of the database. The first data storing unit 643 stores the statistics data created by the statistics unit 641. The creating unit 609 uses the statistics data stored in the first data storing unit 643 when creating the access plan. The first synchronization processing unit 645 performs processing to synchronize the statistics data stored in the first data storing unit 643 with the database management system 131 of the subsystem node 107. The statistics unit 641, the first data storing unit 643, and the first synchronization processing unit 645 are discussed in a fifth embodiment.

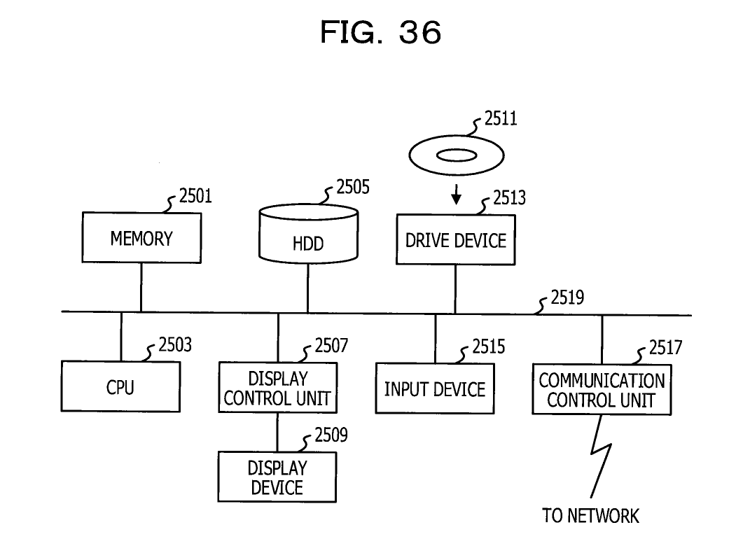

The abovementioned primary system processing unit 601, the receiving unit 603, the connecting unit 605, the first searching unit 607, the creating unit 609, the saving processing unit 611, the transmitting unit 613, the executing unit 615, the replying unit 617, the disconnecting unit 619, the notifying unit 621, the adjusting unit 623, the statistics unit 641, and the first synchronization processing unit 645 are realized by using hardware resources (e.g., FIG. 36) and programs that cause a processor to execute the following processing.

The abovementioned storage region 631 and the first data storing unit 643 are realized by using hardware resources (e.g., FIG. 36).

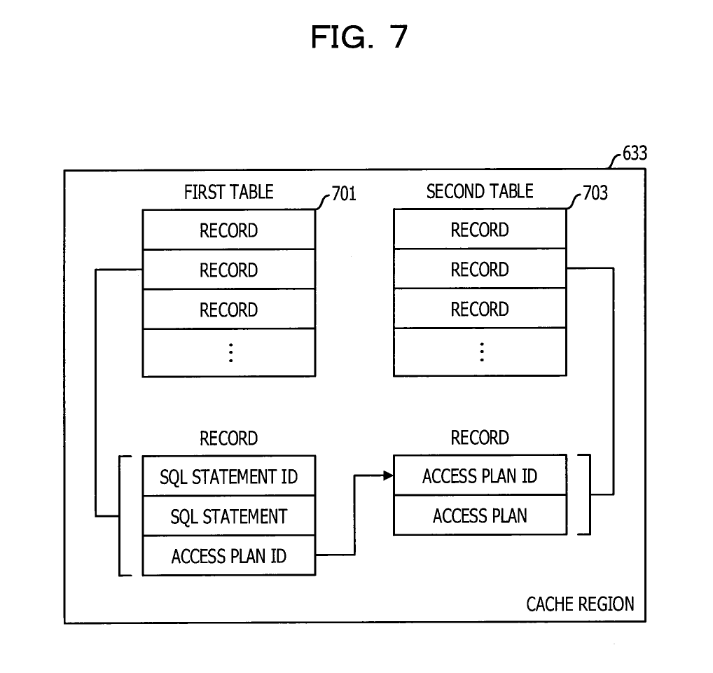

FIG. 7 illustrates a table configuration example of the cache region 633. The cache region 633 stores, for each connection, SQL statements received for the connection, and access plans created based on the SQL statements in association with each other. In the example illustrated in FIG. 7, a first table 701 and a second table 703 are included in the cache region 633. Records in SQL statement units are provided in the first table 701. Records in SQL statement units are provided in the second table 703. The records in the first table 701 are associated with the records in the second table 703.

In this example, fields for setting an ID of the SQL statement stored in the record, the SQL statement, and an ID for the access plan corresponding to the SQL statement, are provided in the records in the first table 701. Meanwhile, fields for setting an ID for the access plan stored in the record and the access plan are provided in the records in the first table 701. For example, access plan IDs are assigned in order to each record. In this way, the records in the first table 701 are associated with the records in the second table 703 according to the access plan IDs. The first table 701 in this example is a hash table for making SQL statement IDs from SQL statement hash values. However, the SQL statements and the access plans may be associated with each other with a configuration different from that of FIG. 7.

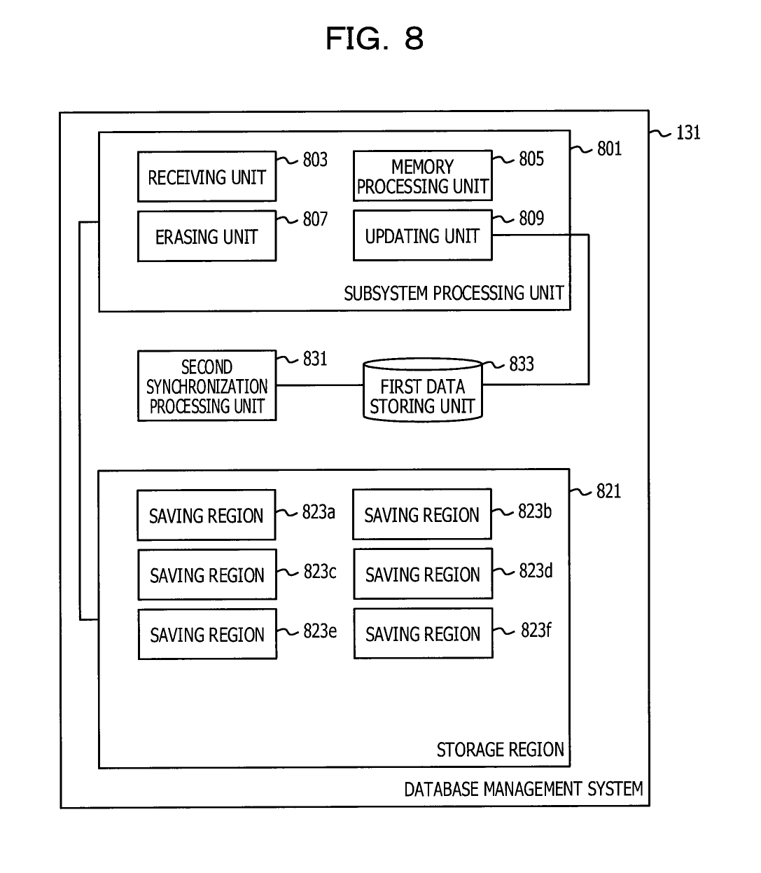

Next, a module configuration of the database management system 131 in the subsystem node 107 will be explained. FIG. 8 illustrates a module configuration example of the database management system 131 in the subsystem node 107. The database management system 131 has a subsystem processing unit 801. The subsystem processing unit 801 receives access plans created by the database management system 121 and previously holds the access plans before the switching of the nodes. The subsystem processing unit 801 has a receiving unit 803, a memory processing unit 805, an erasing unit 807, and an updating unit 809.

The receiving unit receives data from the database management system 121 of the primary system node 103. The memory processing unit 805 secures saving regions 823 and stores access plans and the like included in the saving data in the secured saving regions 823. The erasing unit 807 erases data in the saving regions 823. The updating unit 809 updates an access plan based on new statistics data.

The database management system 131 has a storage region 821. The storage region 821 is provided in a main memory or a cache memory of the subsystem node 107 for example. The storage region 821 is provided with the saving region 823. In this example, saving regions 823a to 823f are provided. The saving regions 823 are provided for each access plan to be saved. The access plans and the data pertaining to the access plans are stored in the saving regions 823.

The database management system 131 has a second synchronization processing unit 831 and a second data storing unit 833. The second synchronization processing unit 831 obtains the statistics data stored in the first data storing unit 643 in FIG. 6 via the first synchronization processing unit 645 in FIG. 6 and stores the statistics data in the second data storing unit 833. The second data storing unit 833 holds the same data as the statistics data stored in the first data storing unit 643 in FIG. 6. That is, the first data storing unit 643 in FIG. 6 and the second data storing unit 833 in FIG. 8 are able to synchronize data due to the first synchronization processing unit 645 in FIG. 6 and the second synchronization processing unit 831 being interlocked.

The abovementioned subsystem processing unit 801, the receiving unit 803, the memory processing unit 805, the erasing unit 807, the updating unit 809, and the second synchronization processing unit 831 are realized by using hardware resources (e.g., FIG. 36) and programs that cause a processor to execute the following processing.

The abovementioned storage region 821 and the second data storing unit 833 are realized by using hardware resources (e.g., FIG. 36).

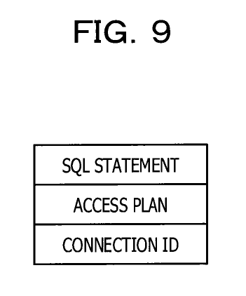

FIG. 9 illustrates an example of the saving region 823 according to the first embodiment. In this example, a SQL statement, an access plan, and a connection ID are stored in association with each other in the saving region 823. The SQL statement is used for linking access plans for example. The connection ID is used, for example, for distinguishing whether there is a created access plan for each connection.

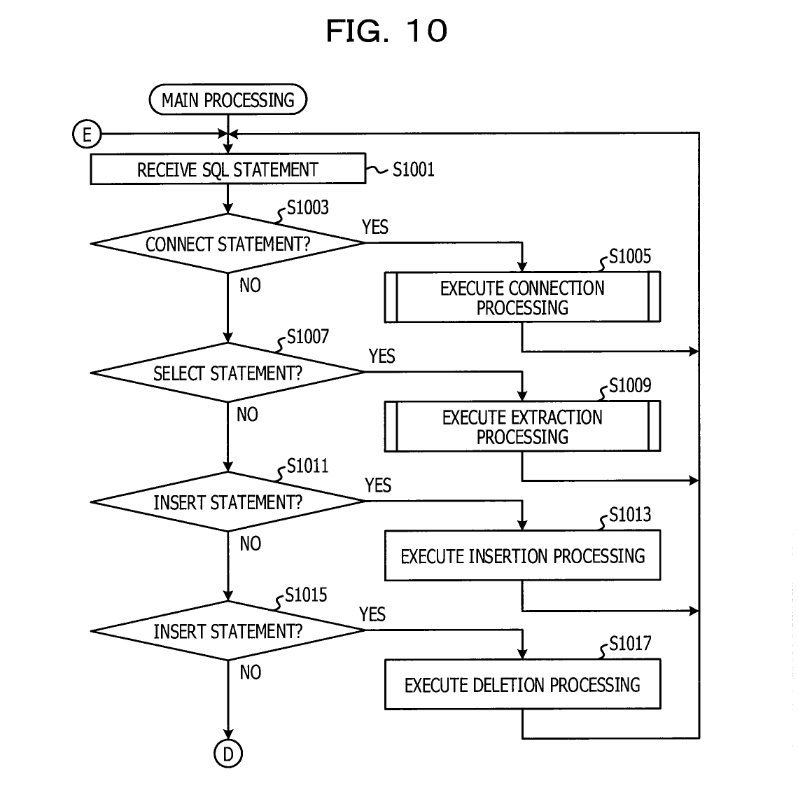

Next, processing of the database management system 121 in the primary system node 103 will be explained. FIG. 10 illustrates a main processing flow of the primary system processing unit 601. The receiving unit 603 waits and then receives an SQL statement from a program module (e.g., the application unit 111a of the application server 113a) that uses the database (S1001).

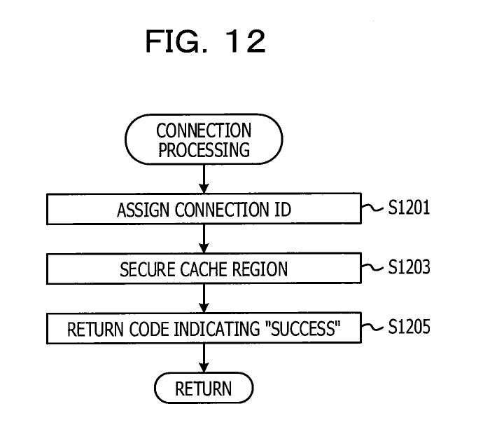

First, the receiving unit 603 determines whether the SQL statement received in S1001 is a CONNECT statement (S1003). The connecting unit 605 executes connection processing if the SQL statement received in S1001 is a CONNECT statement (S1005). The connection processing involves establishing a connection with the program module that is the source of the CONNECT statement. The connection processing is explained using FIG. 12. The routine returns to S1001 when the connection processing is completed.

If the SQL statement received in S1001 is determined to not be a CONNECT statement in S1003, the receiving unit 603 determines whether the SQL statement is a SELECT statement (S1007). The primary system processing unit 601 executes extraction processing if the SQL statement received in S1001 is a SELECT statement (S1009).

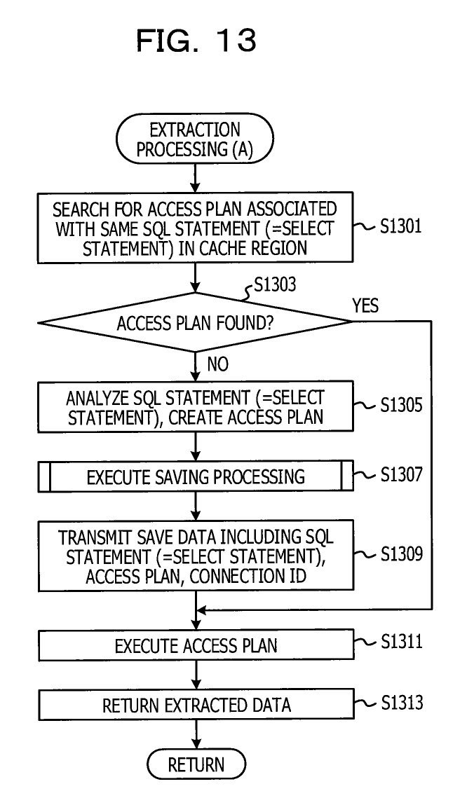

However, if no connection is present with the program module that is the transmission source of the SELECT statement, the extraction processing is not executed. The extraction processing involves extracting the desired data from the designated records included in, for example, a designated table. The extraction processing is explained using FIG. 13. The routine returns to S1001 when the extraction processing is completed.

If the SQL statement received in S1001 is determined to not be a SELECT statement in S1007, the receiving unit 603 determines whether the SQL statement is an INSERT statement (S1011). The receiving unit 603 executes insertion processing if the SQL statement received in S1001 is an INSERT statement (S1013).

However, if no connection is present with the program module that is the transmission source of the INSERT statement, the insertion processing is not executed. The insertion processing involves inserting a designated record in a designated table for example. The insertion processing is explained additionally below. The routine returns to S1001 when the insertion processing is completed.

If the SQL statement received in S1001 is determined to not be an INSERT statement in S1011, the receiving unit 603 determines whether the SQL statement is a DELETE statement (S1015). The receiving unit 603 executes deletion processing if the SQL statement received in S1001 is a DELETE statement (S1017).

However, if no connection is present with the program module that is the transmission source of the DELETE statement, the deletion processing is not executed. The deletion processing involves deleting the designated record included in, for example, the designated table. The deletion processing is explained additionally below. The routine returns to S1001 when the deletion processing is completed.

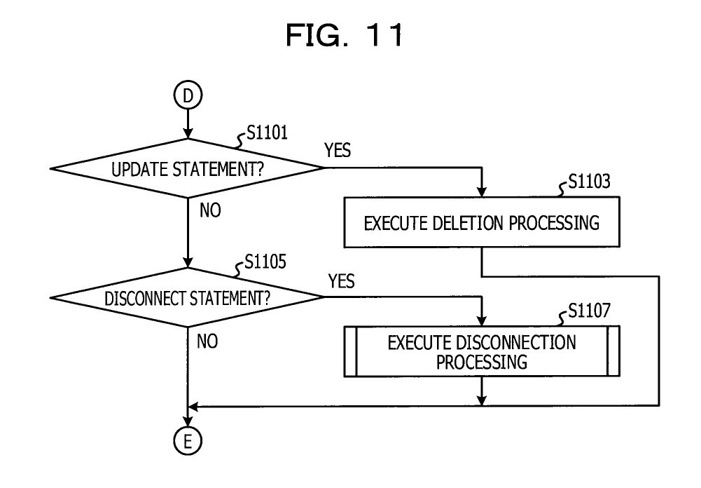

When the SQL statement received in S1001 is determined not to be a DELETE statement in 51015, the routine proceeds to S1101 in FIG. 11 via the terminal D. The receiving unit 603 determines whether the SQL statement received in S1001 is an UPDATE statement (S1101). The primary system processing unit 601 executes updating processing if the SQL statement received in S1001 is an UPDATE statement (S1103). However, if no connection is present with the program module that is the transmission source of the UPDATE statement, the updating processing is not executed. The updating processing involves updating the data in the designated records included in, for example, the designated table. The updating processing is explained additionally below. The routine returns to S1001 when the updating processing is completed.

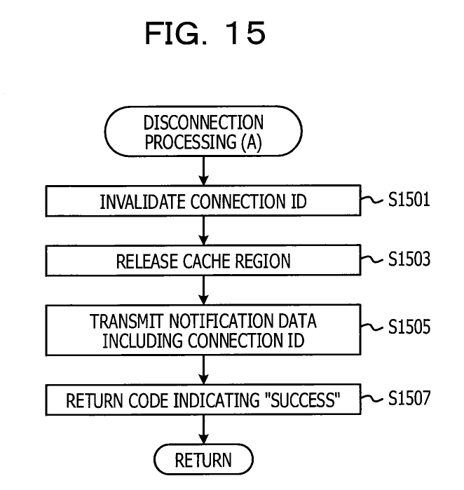

When the SQL statement received in S1001 in FIG. 10 is determined to not be an UPDATE statement in S1101, the receiving unit 603 determines whether the SQL statement received in S1001 in FIG. 10 is a DISCONNECT statement (S1105). The disconnecting unit 619 executes disconnection processing if the SQL statement received in S1001 in FIG. 10 is a DISCONNECT statement (S1107). However, if no connection is present with the program module that is the transmission source of the DISCONNECT statement, the disconnection processing is not executed. The disconnection processing is explained using FIG. 15. The routine returns to S1001 when the disconnection processing is completed. If the SQL statement received in S1001 in FIG. 10 is determined to not be a DISCONNECT statement in S1105, the routine returns to S1001 in FIG. 10.

Next, the connection processing will be explained. The feature of establishing a connection with the program module that is the source of a CONNECT statement is the same as the prior art. The processing pertaining to the present embodiment within the processing of the prior art and the processing of the present embodiment will be discussed below. FIG. 12 illustrates a connection processing flow. The connecting unit 605 assigns a connection ID to the established connection (S1201). The connecting unit 605 secures the cache region 633 corresponding to the connection in the storage region 631 (S1203). In this example, the connection ID is set to the header section of the secured cache region 633. The connecting unit 605 returns a code indicating “success” to the program module that is the transmission source of the CONNECT statement (S1205).

Next, the extraction processing will be explained. FIG. 13 illustrates an extraction processing (A) flow. The first searching unit 607 searches for the access plan associated with a SQL statement (=SELECT statement) that is the same as the SQL statement received in S1001 in FIG. 10 within the cache region 633 corresponding to the assumed connection (S1301). The first searching unit 607 determines whether there is an access plan associated with a SQL statement that is the same as the SQL statement received in S1001 in FIG. 10 (S1303). There would be no access plan associated with a SQL statement that is the same as the original SQL statement with regard to a SQL statement that is received first for the connection. Conversely, there would be an access plan associated with a SQL statement that is the same as the original SQL statement with regard to a SQL statement that is has been previously received for the connection.

If it is determined that there is no access plan associated with a SQL statement that is the same as the SQL statement received in S1001 in FIG. 10, the creating unit 609 analyzes the SQL statement (=SELECT statement) and creates an access plan (S1305). The creating unit 609 at this time creates the access plan based on the statistics data stored in the first data storing unit 643.

The saving processing unit 611 executes saving processing (S1307). The saving processing involves saving the access plan created in S1305 in the cache region 633 associated with the assumed connection.

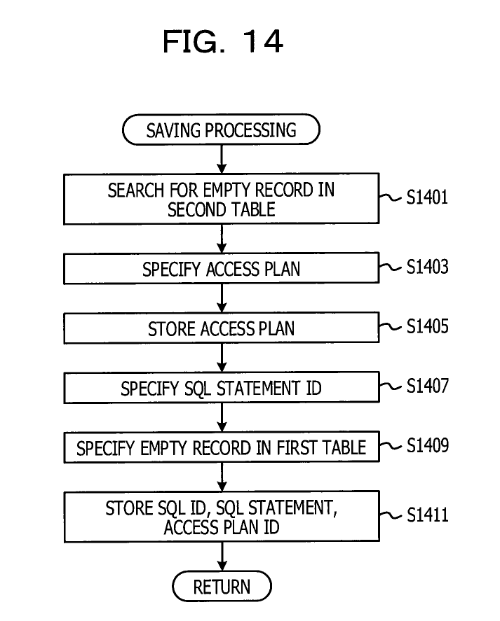

Next, the saving processing will be explained. FIG. 14 illustrates a saving processing flow. The saving processing unit 611 searches for empty records in the second table 703 (S1401). The saving processing unit 611 specifies an access plan ID of the empty record (S1403). The saving processing unit 611 stores the access plan created in S1305 in the empty record (S1405). The saving processing unit 611 specifies a SQL statement ID based on the SQL statement (S1407). In this example, the saving processing unit 611 calculates a SQL statement hash value and uses the calculated hash value as the SQL statement ID. The saving processing unit 611 specifies an empty record in the first table 701 (S1409) and stores the SQL statement ID, the SQL statement, and the access plan ID in the empty record (S1411). The routine returns to the processing in S1309 in FIG. 13 when the saving processing is completed.

The explanation now returns to FIG. 13. The transmitting unit 613 transmits saving data including the SQL statement (=SELECT statement), the access plan, and the connection ID (S1309). The executing unit 615 executes the access plan (S1311). The replying unit 617 returns the data extracted as a result of executing the access plan to the transmission source of the SQL statement (S1313).

When it is determined in S1303 that there is an access plan associated with a SQL statement that is the same as the SQL statement received in S1001 in FIG. 10, the routine proceeds to the processing in S1311. The explanation of the extraction processing (A) is complete.

In the insertion processing in S1013 illustrated in FIG. 10, the SQL statement is an INSERT statement and an access plan is created based on the INSERT statement in the same order as in the extraction processing (A) illustrated in FIG. 13. The transmitting unit 613 includes the access plan in the saving data and the executing unit 615 executes the access plan. However, the processing in S1313 in the extraction processing (A) is not performed.

In the deletion processing in S1017 illustrated in FIG. 10, the SQL statement is a DELETE statement and an access plan based on the DELETE statement is created in the same order as the extraction processing (A) illustrated in FIG. 13. The transmitting unit 613 includes the access plan in the saving data and the executing unit 615 executes the access plan. However, the processing in S1313 in the extraction processing (A) is not performed.

In the updating processing in S1103 illustrated in FIG. 11, the SQL statement is an UPDATE statement and an access plan based on the UPDATE statement is created in the same order as the extraction processing (A) illustrated in FIG. 13. The transmitting unit 613 includes the access plan in the saving data and the executing unit 615 executes the access plan. However, the processing in S1313 in the extraction processing (A) is not performed.

Next, the disconnection processing will be explained. The feature of releasing the connection with the program module that is the source of a DISCONNECT statement is the same as the prior art. The processing pertaining to the present embodiment within the processing of the prior art and the processing of the present embodiment will be discussed below.

FIG. 15 illustrates a disconnection processing (A) flow. The disconnecting unit 619 invalidates the ID of the released connection (S1501). The disconnecting unit 619 specifies the cache region 633 in which the ID of the released connection is set in the header section thereof, and releases the cache region 633 (S1503). That is, the data in the cache region 633 is erased. The notifying unit 621 transmits notification data including the ID of the released connection to the database management system 131 of the subsystem node 107 (S1505). The disconnecting unit 619 returns a code indicating “success” to the program module that is the transmission source of the DISCONNECT statement (51507).

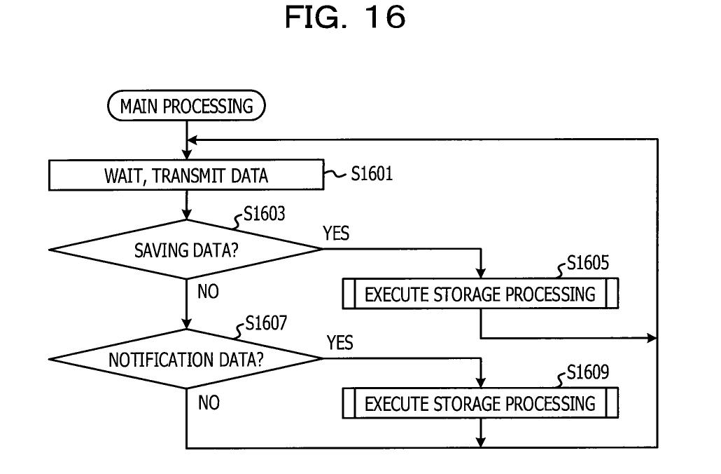

Next, processing of the database management system 131 of the subsystem node 107 will be explained. FIG. 16 illustrates a main processing flow of the subsystem processing unit 801. The receiving unit 803 waits and then receives data from the database management system 121 of the primary system node 103 (S1601). The memory processing unit 805 determines whether the received data is saving data (S1603). If it is determined that the received data is saving data, the memory processing unit 805 executes storage processing (S1605).

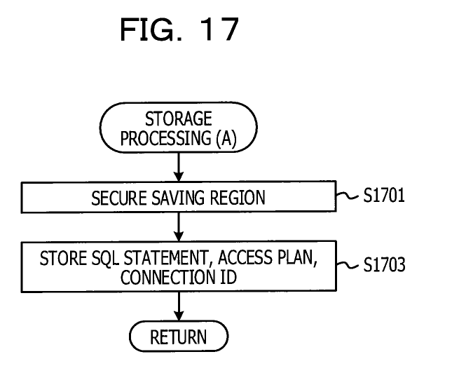

FIG. 17 illustrates a storage processing (A) flow. The memory processing unit 805 secures a new saving region 823 in the storage region 821 (S1701). The memory processing unit 805 stores the SQL statement, the access plan, and the connection ID included in the saving data in the new saving region 823 (S1703). The routine returns to S1601 in FIG. 16 when the storage processing is completed.

Returning to the explanation in FIG. 16, when it is determined in S1603 that the data received in S1601 is not saving data, the erasing unit 807 determines whether the data received in S1601 is notification data (S1607). If it is determined that the data received in S1601 is notification data, the erasing unit 807 executes the erasing processing (S1609).

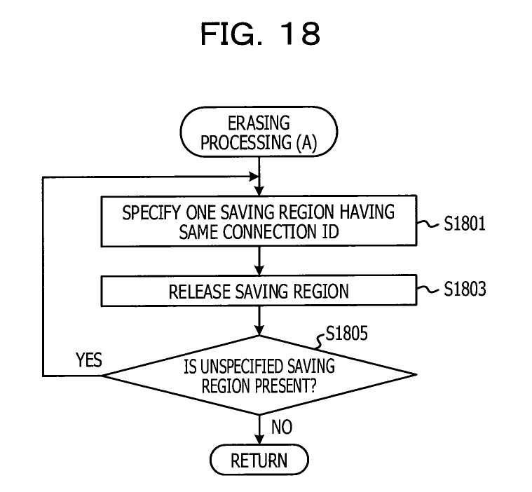

FIG. 18 illustrates an erasing processing (A) flow. The erasing unit 807 specifies one saving region 823 in which a connection ID that is the same as the connection ID included in the notification data is set in the header section (S1801). The erasing unit 807 releases the specified saving region 823 (S1803). That is, the data in the saving region 823 is erased. The erasing unit 807 determines whether there is an unspecified saving region 823 that is a saving region 823 in which a connection ID that is the same as the connection ID included in the notification data is set in the header section (S1805). If it is determined that there is an unspecified saving region 823, the routine returns to S1801. Conversely, if it is determined that there is no unspecified saving region 823, the erasing processing (A) is completed and the routine returns to S1601 in FIG. 16.

Returning to the explanation in FIG. 16, when the erasing unit 807 determines in S1607 that the data received in S1601 is not notification data, the routine returns to S1601.

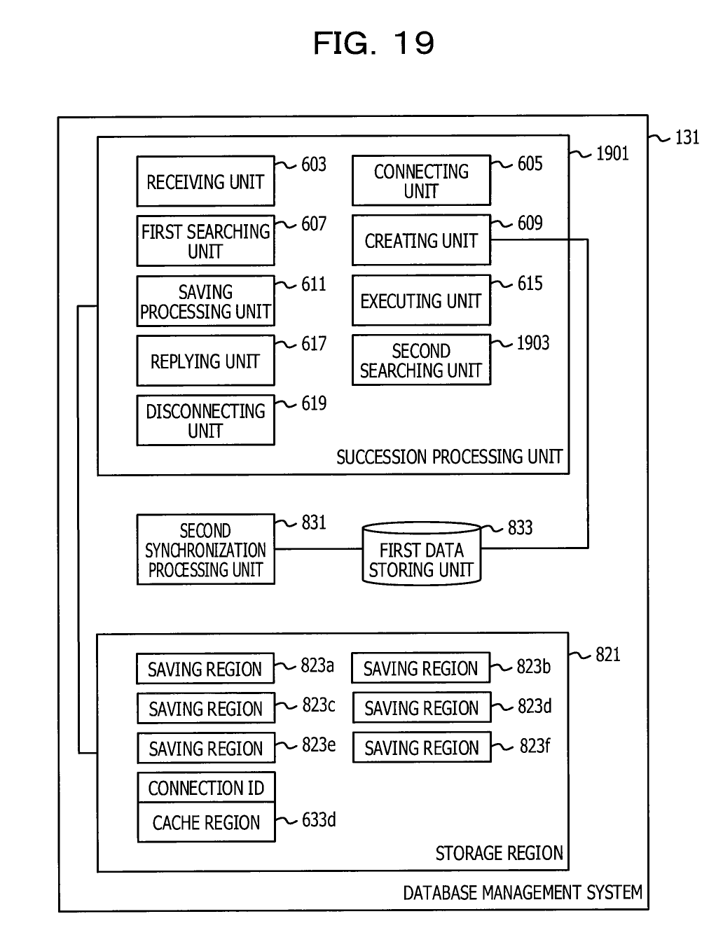

The following is an explanation regarding a new primary system node switched from the subsystem node 107 due to a node switch. FIG. 19 illustrates a module configuration example of the database management system 131 in the new primary system node. A succession processing unit 1901 inherits the processing from the primary system processing unit 601 of the former primary system node in response to the switching of the nodes. The succession processing unit 1901 uses the access plan stored in the saving region 823 in the storage region 821 to perform processing in accordance with the SQL statement. The succession processing unit 1901 has the receiving unit 603, the connecting unit 605, the first searching unit 607, the creating unit 609, the saving processing unit 611, the executing unit 615, the replying unit 617, the disconnecting unit 619, and a second searching unit 1903. The receiving unit 603 the connecting unit 605, the first searching unit 607, the creating unit 609, the saving processing unit 611, the executing unit 615, the replying unit 617, and the disconnecting unit 619 are the same as the modules included in the primary system processing unit illustrated in FIG. 6.

The second searching unit 1903 searches for a saving region 823 having a SQL statement that is the same as the SQL statement received by the receiving unit 603.

The cache region 633 is provided in the storage region 821 in the same way as the storage region 631 in FIG. 6. The configuration of the cache region 633 is described in FIG. 7.

The abovementioned succession processing unit 1901, the receiving unit 603, the connecting unit 605, the first searching unit 607, the creating unit 609, the saving processing unit 611, the executing unit 615, the replying unit 617, the disconnecting unit 619, and the second searching unit 1903 are realized by using hardware resources (e.g., FIG. 36) and programs that cause a processor to execute the following processing.

Processing by the succession processing unit 1901 will be explained next. It is assumed that, due to the switching of the nodes, a connection is established between the database management system 131 of the new primary system node and the program module that is the transmission source of the SQL statement and that an ID for the connection is assigned. The main processing of the succession processing unit 1901 is the same as the main processing of the primary system processing unit 601 illustrated in FIG. 10. Features different from the processing of the primary system processing unit 601 will be explained below using the extraction processing as an example.

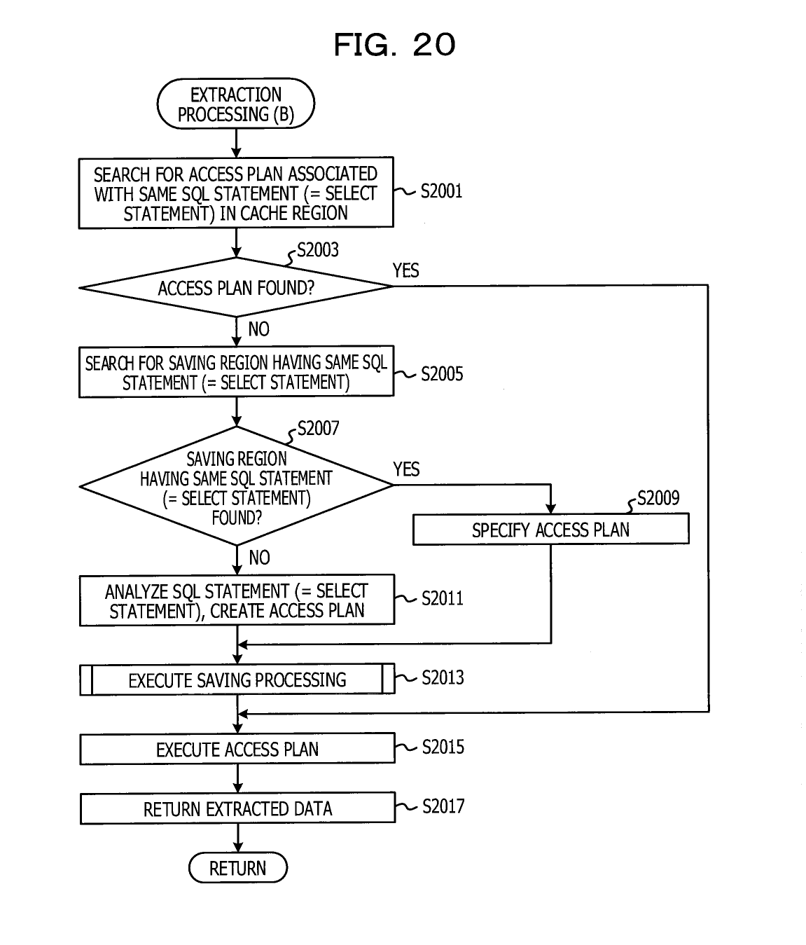

The succession processing unit 1901 executes an extraction processing (B) in place of the extraction processing (A) illustrated in FIG. 13. FIG. 20 illustrates the extraction processing (B) flow. Similar to the extraction processing (A), the first searching unit 607 searches for the access plan associated with a SQL statement (=SELECT statement) that is the same as the SQL statement received in S1001 in FIG. 10 within the cache region 633 corresponding to the assumed connection (S2001). Similar to the extraction processing (A), the first searching unit 607 determines whether there is an access plan associated with a SQL statement that is the same as the SQL statement received in S1001 in FIG. 10 (S2003).

If it is determined that there is no access plan associated with a SQL statement that is the same as the SQL statement received in S1001 in FIG. 10, the executing unit 615 executes the access plan (S2015). The replying unit 617 returns the data extracted as a result of executing the access plan to the transmission source of the SQL statement (S2017).

Conversely in S2003, if it is determined that there is no access plan associated with a SQL statement (=SELECT statement) that is the same as the SQL statement received in S1001 in FIG. 10, the second searching unit 1903 searches for the saving region 823 having a SQL statement that is the same as the SQL statement received in S1001 in FIG. 10 (S2005). The second searching unit 1903 determines whether there is a saving region 823 having a SQL statement (=SELECT statement) that is the same as the SQL statement received in S1001 in FIG. 10 (S2007).

If it is determined that there is a saving region 823 having a SQL statement (=SELECT statement) that is the same as the SQL statement received in S1001 in FIG. 10, the second searching unit 1903 reads the access plan included in the saving region 823 (S2009). That is, the second searching unit 1903 reads the access plan associated with the SQL statement received in S1001.

Conversely, if it is determined that there is no saving region 823 having an access plan associated with a SQL statement that is the same as the SQL statement received in S1001 in FIG. 10, the creating unit 609 analyzes the SQL statement (=SELECT statement) and creates an access plan (S2011).

The saving processing unit 611 then executes saving processing in the same way as in the extraction processing (A) (S2013). The access plan newly created and the access plan read from the saving region 823 are stored in the cache region 633 as a result of the saving processing. The executing unit 615 executes the access plan (S2015) and the replying unit 617 returns the extracted data (S2017). The routine returns to S1001 in FIG. 10 when the extraction processing (B) is completed.

In the insertion processing in S1013 illustrated in FIG. 10, the SQL statement is an INSERT statement and an access plan is created based on the INSERT statement in the same order as in the extraction processing (B) illustrated in FIG. 20. The transmitting unit 613 includes the access plan in the saving data and the executing unit 615 executes the access plan. However, the processing in S2017 in the extraction processing (B) is not performed.

In the deletion processing in S1017 illustrated in FIG. 10, the SQL statement is a DELETE statement and an access plan based on the DELETE statement is created in the same order as the extraction processing (B) illustrated in FIG. 20. The transmitting unit 613 includes the access plan in the saving data and the executing unit 615 executes the access plan. However, the processing in 52017 in the extraction processing (B) is not performed.

In the updating processing in S1103 illustrated in FIG. 11, the SQL statement is an UPDATE statement and an access plan based on the UPDATE statement is created in the same order as the extraction processing (B) illustrated in FIG. 20. The transmitting unit 613 includes the access plan in the saving data and the executing unit 615 executes the access plan. However, the processing in S2017 in the extraction processing (B) is not performed.

According to the present embodiment, a shortage of the remaining capacity of the storage region 821 for storing access plans can be suppressed in the database management system 131 of the subsystem node 107.

### Second Embodiment

The present embodiment discusses an example in which the subsystem node 107 does not attempt to duplicate and store the access plan corresponding to the same SQL statement.

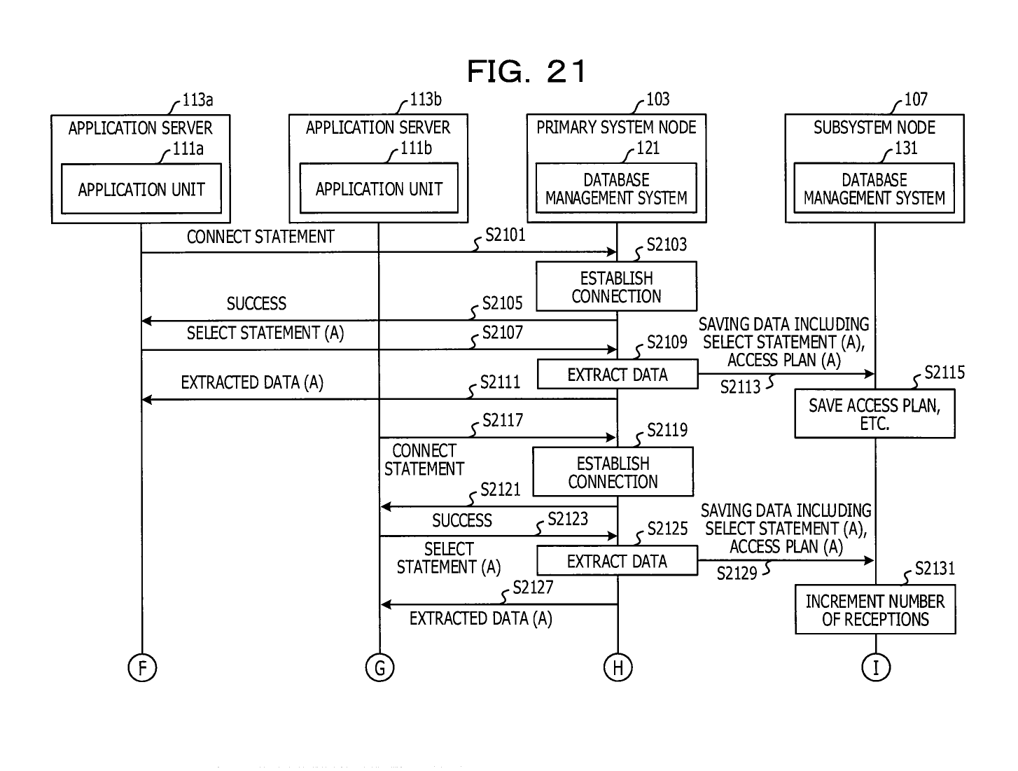

FIG. 21 illustrates an example of a sequence according to the second embodiment. In this example, it is assumed that a duplicate database system having the primary system node 103 and the subsystem node 107 is used for work by the application unit 111a in the application server 113a and for work by the application unit 111b in the application server 113b. Moreover, in this example a connection between the application unit 111a of the application server 113a and the database management system 121 of the primary system node 103 is present concurrently with a connection between the application unit 111b of the application server 113b and the database management system 121 of the primary system node 103.

An access request from the application unit 111a of the application server 113a to the database management system 121 of the primary system node 103, an access request from the application unit 111a of the application server 113a to the database management system 131 of the primary system node 107, an access request from the application unit 111b of the application server 113b to the database management system 121 of the primary system node 103, and an access request from the application unit 111b of the application server 113b to the database management system 131 of the subsystem node 107 are written for example in the format of a SQL statement. Access to the database may be requested using a question statement using a database language other than SQL. The sequence in this example is based on SQL specifications.

The application unit 111a of the application server 113a first transmits a CONNECT statement to the database management system 121 of the primary system node 103 (S2101).

Upon receiving the CONNECT statement, the database management system 121 of the primary system node 103 establishes a connection with the application unit 111a of the application server 113a that is the source of the request (S2103). At this time, a connection ID for identifying the established connection is assigned. The database management system 121 of the primary system node 103 then returns a code indicating “success” to the application unit 111a of the application server 113a (S2105).

The application unit 111a of the application server 113a transmits a SELECT statement (A) to the database management system 121 of the primary system node 103 while the connection is established (S2107). The SELECT statement (A) assumes the connection established in S2103. The SELECT statement (A) signifies a SELECT statement of the type A in the same way as in the first embodiment.

The database management system 121 of the primary system node 103 receives the SELECT statement (A) and extracts data in accordance with the SELECT statement (A) (S2109). An access plan (A) based on the SELECT statement (A) is created at this time and the created access plan (A) is executed. As a result, the desired data is extracted from the designated records included in, for example, the designated table. The database management system 121 of the primary system node 103 temporarily stores the created access plan (A) in the cache region 633 inside the database management system 121 of the primary system node 103. The database management system 121 of the primary system node 103 then returns the extracted data (A) to the application unit 111a of the application server 113a (S2111). The data (A) signifies the data extracted based on the SELECT statement (A) in the same way as in the example in the first embodiment.

During the extraction of the data in S2109, the database management system 121 of the primary system node 103 creates saving data including the SELECT statement (A) and the access plan (A) and transmits the created saving data to the database management system 131 of the subsystem node 107 (S2113).

The database management system 131 of the subsystem node 107 receives the saving data and determines whether the access plan included in the saving data has been previously saved. In this example, the access plan (A) has not been previously saved, therefore the access plan and the data pertaining to the access plan included in the saving data are saved (S2115). The database management system 131 of the subsystem node 107 then stores “1” as the number of receptions of the access plan (A). The database management system 131 of the subsystem node 107 uses the SELECT statement (A) as identification data for specifying the access plan (A). The access plan created in this way by the database management system 121 of the primary system node 103 and the data pertaining to the access plan are transmitted to the database management system 131 of the subsystem node 107 and saved in the database management system 131 of the subsystem node 107. In the present embodiment, the number of receptions of the access plan is counted.

The application unit 111b of the application server 113b first transmits a CONNECT statement to the database management system 121 of the primary system node 103 (S2117).

Upon receiving the CONNECT statement, the database management system 121 of the primary system node 103 establishes a connection with the application unit 111b of the application server 113b that is the source of the request (S2119). At this time, a connection ID for identifying the established connection is assigned.

The database management system 121 of the primary system node 103 then returns a code indicating “success” to the application unit 111b of the application server 113b (S2121).

Next, the application unit 111b of the application server 113b transmits a SELECT statement (A) to the database management system 121 of the primary system node 103 while the connection is established (S2123). The SELECT statement (A) assumes the connection established in S2119.

The database management system 121 of the primary system node 103 receives the SELECT statement (A) and extracts data in accordance with the SELECT statement (A) (S2125). An access plan (A) based on the SELECT statement (A) is created at this time and the created access plan (A) is executed. As a result, the desired data is extracted from the designated records included in, for example, a designated table. The database management system 121 of the primary system node 103 temporarily stores the created access plan (A) in the cache region 633 inside the database management system 121 of the primary system node 103. The cache region 633 is provided for each connection. When different connections are assumed even with the same SQL statement, access plans based on the SQL statements are saved separately in different cache regions 633. The database management system 121 of the primary system node 103 then returns the extracted data (A) to the application unit 111b of the application server 113b (S2127).

During the extraction of the data in S2125, the database management system 121 of the primary system node 103 creates saving data including the SELECT statement (A) and the access plan (A) and transmits the created saving data to the database management system 131 of the subsystem node 107 (S2129).

The database management system 131 of the subsystem node 107 receives the saving data and determines whether the access plan (A) included in the saving data has been previously saved. In this example, the access plan (A) is previously saved and therefore the number of receptions of the access plan (A) is incremented to “2” (S2131). In this way, when the database management system 131 of the subsystem node 107 determines that a previously received access plan has been received again using the SQL statement as a key regardless of different connections, the number of receptions is incremented. That is, saved access plans are not duplicated in the database management system 131 of the subsystem node 107.

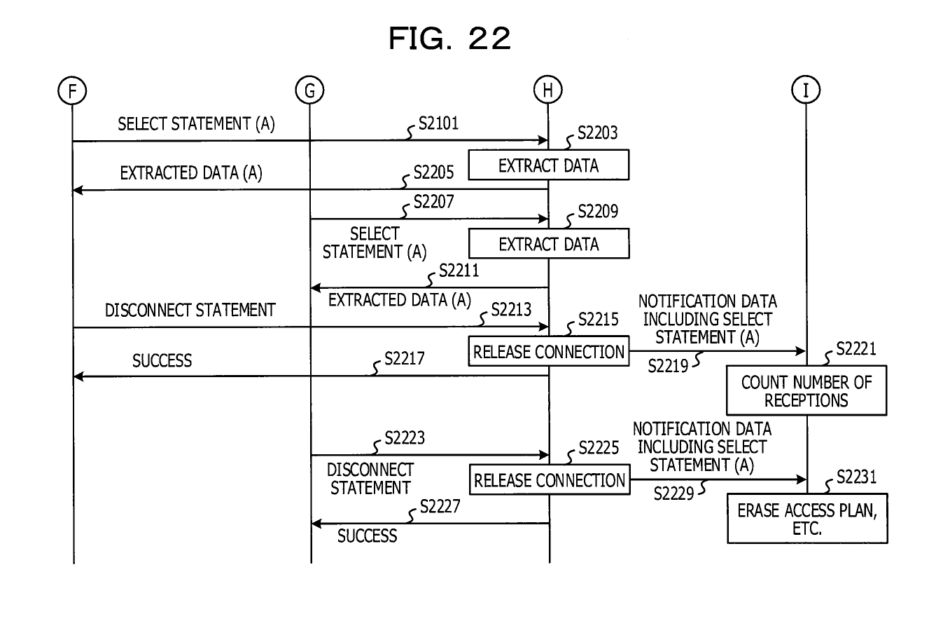

The sequence is continued in FIG. 22 through terminals F, G, and H. The sequence when the same SQL statement is received again is the same as the example in the first embodiment. The application unit 111a of the application server 113a retransmits the SELECT statement (A) to the database management system 121 of the primary system node 103 (S2201). The SELECT statement (A) transmitted in S2201 is the same as the SELECT statement (A) transmitted in S2107 and S2123 in FIG. 21. The retransmitted SELECT statement (A) assumes the connection established in S2103.

The database management system 121 of the primary system node 103 receives the SELECT statement (A) and extracts data in accordance with the SELECT statement (A) (S2203). The access plan (A) created in S2109 is read from the cache region 633 and the read access plan (A) is executed. That is, processing to create the access plan (A) based on the SELECT statement is omitted. The desired data is then extracted from the designated records included in, for example, the designated table. The database management system 121 of the primary system node 103 then returns the extracted data (A) to the application unit 111a of the application server 113a (S2205).

The application unit 111b of the application server 113b retransmits the SELECT statement (A) to the database management system 121 of the primary system node 103 (S2207). The SELECT statement (A) transmitted in S2207 is the same as the SELECT statement (A) transmitted in S2107, S2123, and S2201 in FIG. 21. The retransmitted SELECT statement (A) assumes the connection established in S2119 in FIG. 21.

The database management system 121 of the primary system node 103 receives the SELECT statement (A) and extracts data in accordance with the SELECT statement (A) (S2209). The access plan (A) created in S2125 is read from the cache region 633 and the read access plan (A) is executed. Similarly, processing to create the access plan (A) based on the SELECT statement is omitted. The desired data is then extracted from the designated records included in, for example, the designated table. The database management system 121 of the primary system node 103 then returns the extracted data (A) to the application unit 111b of the application server 113b (S2211).

The application unit 111a of the application server 113a transmits a DISCONNECT statement to the database management system 121 of the primary system node 103 when the series of accesses assuming the connection established is completed (S2213).

Upon receiving the DISCONNECT statement, the database management system 121 of the primary system node 103 releases the connection with the application unit 111a of the application server 113a that is the source of the request (S2215). At this time, the cache region 633 corresponding to the released connection is released. Therefore, the access plan based on the received SQL statement assuming the released connection is erased. In this example, the access plan (A) is erased. If a plurality of access plans based on the received SQL statement assuming the connection are present, the respective access plans are erased.

The database management system 121 of the primary system node 103 then returns a code indicating “success” to the application unit 111a of the application server 113a (S2217).

During the release of the connection indicated in S2215, the database management system 121 of the primary system node 103 transmits notification data including the SQL statement (the SELECT statement (A) in this example) that specifies the erased access plan to the database management system 131 of the subsystem node 107 (S2219). When a plurality of access plans are erased, the SQL statements for specifying each of the access plans are added to the notification data.

The database management system 131 of the subsystem node 107 searches for the access plan using the SQL statement (the SELECT statement (A) in this example) included in the notification data as a key. When a plurality of SQL statements are included in the notification data, the searching of the access plan is repeated using the SQL statements as keys. The database management system 131 of the subsystem node 107 then determines whether the number of receptions of the found access plan is “1” or “2”. If the number of receptions of the access plan is “2” or more, the database management system 131 of the subsystem node 107 decrements the number of receptions of the access plan (S2221). In this example, the “2” for the number of receptions of the access plan (A) found with the SELECT statement (A) is updated to “1”.

The following discusses the case in which the number of receptions of the found access plan is “1”. The application unit 111b of the application server 113b also transmits a DISCONNECT statement to the database management system 121 of the primary system node 103 when the series of accesses assuming the connection established is completed (S2223).

Upon receiving the DISCONNECT statement, the database management system 121 of the primary system node 103 releases the connection with the application unit 111b of the application server 113b that is the source of the request (S2225). At this time, the cache region 633 corresponding to the released connection is released in the same way as in S2215. In this example, the access plan (A) is erased. The database management system 121 of the primary system node 103 then returns a code indicating “success” to the application unit 111b of the application server 113b (S2227).

During the release of the connection indicated in S2225, the database management system 121 of the primary system node 103 transmits notification data including the SQL statement (the SELECT statement (A) in this example) that specifies the erased access plan to the database management system 131 of the subsystem node 107 (S2229). When a plurality of access plans are erased, the SQL statements for specifying each of the access plans are added to the notification data in the same way as in S2215.

The database management system 131 of the subsystem node 107 searches for the access plan using the SQL statement (the SELECT statement (A) in this example) included in the notification data as a key. When a plurality of SQL statements are included in the notification data, the searching of the access plan is repeated using the SQL statements as keys. The database management system 131 of the subsystem node 107 then determines whether the number of receptions of the found access plans is “1” or “2” in the same way as in S2221. When it is determined that the number of receptions of the access plan is “1”, the database management system 131 of the subsystem node 107 erases the access plan and the data pertaining to the access plan (S2231). In this example, the access plan (A) and the data pertaining to the access plan (A) are erased.

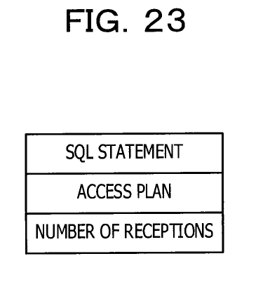

FIG. 23 illustrates an example of the saving region 823 according to the second embodiment. In this example, the SQL statement, the access plan, and the number of receptions are stored in the saving region 823 in association with each other. The SQL statement is used for linking access plans for example in the same way as in the first embodiment. The database management system 131 of the subsystem node 107 of the present embodiment handles the access plans based on the same SQL statement as the same access plan regardless of whether there is a different connection. The database management system 131 of the subsystem node 107 then determines whether an access plan has been created for the same SQL statement among the several connections based on the number of receptions of the same access plan. Furthermore, when a connection is released, the number of receptions is decremented by one so that the number of connections currently valid matches the number of receptions.

Next, processing of the primary system processing unit 601 in the database management system 121 according to the second embodiment will be explained. The main processing of the primary system processing unit 601 is the same as the processing illustrated in FIG. 10. The extraction processing will be discussed next as an example with regard to the features that are different from the first embodiment.

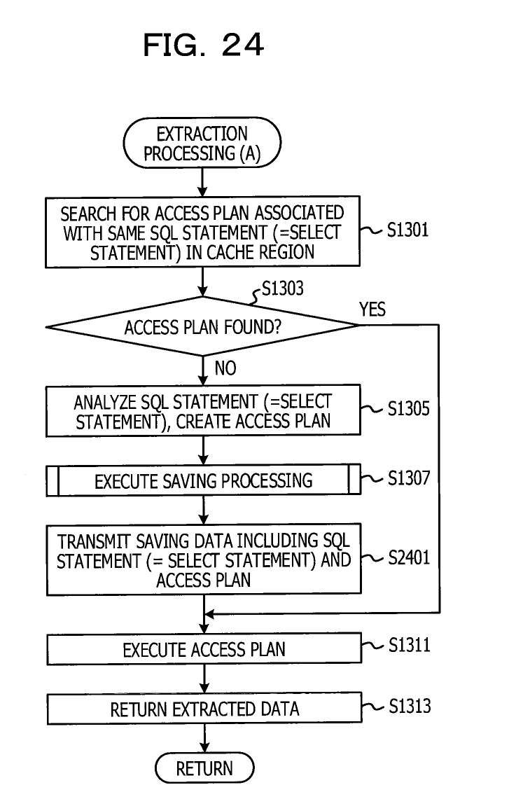

The primary system processing unit 601 in 51009 in FIG. 10 executes an extraction processing (C) in place of the extraction processing (A) illustrated in FIG. 13. FIG. 24 illustrates the extraction processing (C) flow. The processing from S3101 to S1307 is the same as the processing of the first embodiment illustrated in FIG. 13.

When the saving processing in S1307 is completed, the transmitting unit 613 transmits saving data including the SQL statement (=SELECT statement) and the access plan (S2401).

The processing from S3111 to S1313 is the same as the processing of the first embodiment illustrated in FIG. 13.

In the case of the insertion processing in S1013 illustrated in FIG. 10, the transmitting unit 613 transmits the saving data including the SQL statement (=INSERT statement) and the access plan. In the case of the deletion processing in S1017 illustrated in FIG. 10, the transmitting unit 613 transmits the saving data including the SQL statement (=DELETE statement) and the access plan. In the case of the updating processing in S1103 illustrated in FIG. 11, the transmitting unit 613 transmits the saving data including the SQL statement (=UPDATE statement) and the access plan.

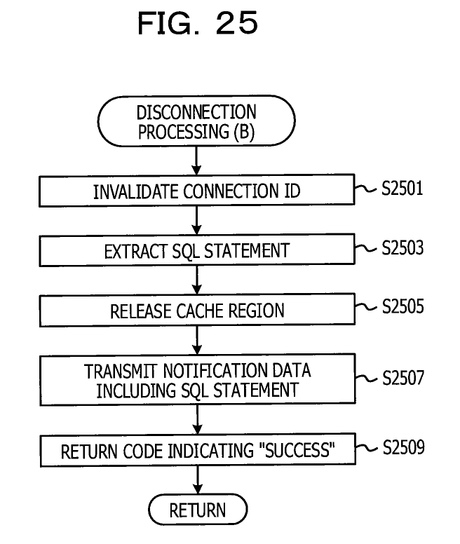

Furthermore, the disconnecting unit 619 of the primary system processing unit 601 executes disconnection processing (B) in place of the disconnection processing (A) in S1107 in FIG. 11. FIG. 25 illustrates the disconnection processing (B) flow. The disconnecting unit 619 invalidates the ID of the released connection (S2501). The disconnecting unit 619 extracts the SQL statement from the cache region 633 corresponding to the connection ID (S2503). The disconnecting unit 619 releases the cache region 633 corresponding to the connection ID (S2505). That is, the data in the cache region 633 is erased. The notifying unit 621 transmits notification data including the SQL statement extracted in S2503 to the database management system 131 of the subsystem node 107 (S2507). The disconnecting unit 619 returns a code indicating “success” to the program module that is the transmission source of the DISCONNECT statement (S2509).

Next, processing of the subsystem processing unit 801 in the database management system 131 according to the second embodiment will be explained. The main processing of the subsystem processing unit 801 is the same as illustrated in FIG. 16. The features that are different from the first embodiment will be explained next.

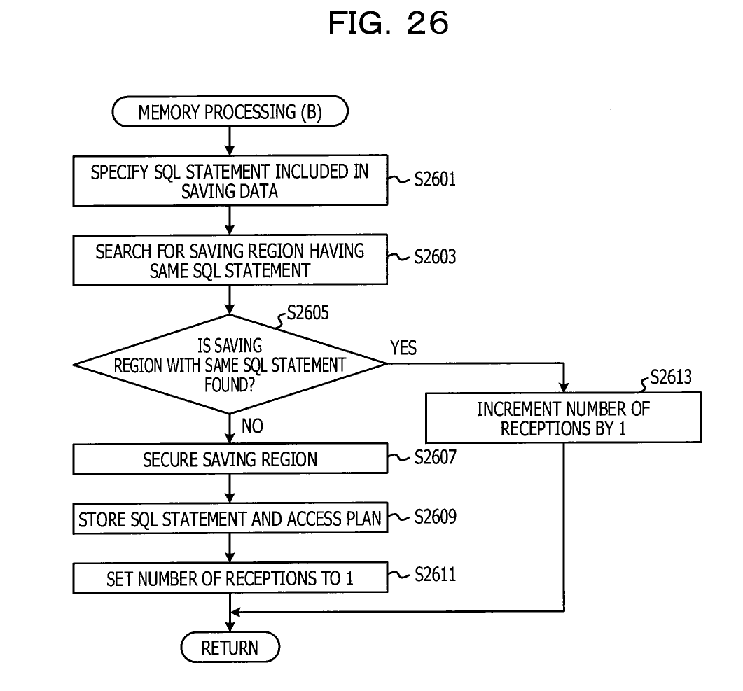

The memory processing unit 805 executes in S1605 in FIG. 15 storage processing (B) in place of the storage processing (A) illustrated in FIG. 17. FIG. 26 illustrates the storage processing (B) flow. The memory processing unit 805 specifies the SQL statement included in the saving data received in S1601 in FIG. 16 (S2601). The memory processing unit 805 searches for the saving region 823 that has the SQL statement that is the same as the SQL statement specified in S2601 (S2603). The memory processing unit 805 determines whether there is a saving region 823 that has the SQL statement that is the same as the SQL statement specified in S2601 (S2605).

When it is determined that no saving region 823 has the SQL statement that is the same as the SQL statement specified in S2601, the memory processing unit 805 secures a new saving region 823 in the storage region 821 (S2607). The memory processing unit 805 stores the SQL statement and the access plan included in the saving data in the new saving region 823 (S2609). The memory processing unit 805 sets the number of receptions included in the saving region 823 to “1” (S2611).

When it is determined in S2605 that there is a saving region 823 having the SQL statement that is the same as the SQL statement specified in S2601, the memory processing unit 805 adds “1” to the number of receptions of the saving region 823 (S2613). Therefore, the number of receptions of the saving region 823 reaches “2” or more. The routine returns to S1601 in FIG. 16 when the storage processing (B) is completed.

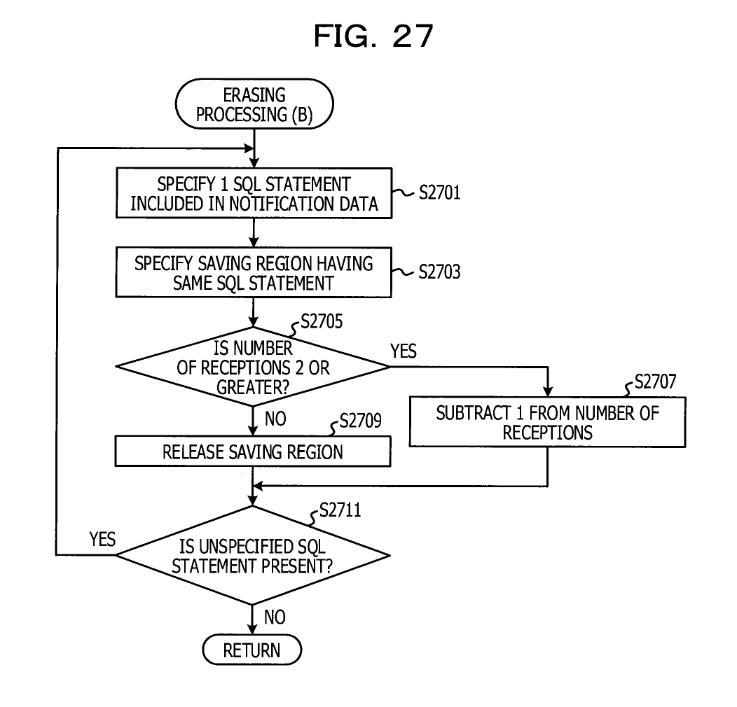

The erasing unit 807 executes in S1609 in FIG. 16 erasing processing (B) in place of the erasing processing (A) illustrated in FIG. 18. FIG. 27 illustrates the erasing processing (B) flow. The erasing unit 807 specifies one SQL statement included in the notification data received in S1601 in FIG. 16 (S2701). The erasing unit 807 specifies the saving region 823 that has the SQL statement that is the same as the specified SQL statement (S2703). The erasing unit 807 determines whether the number of receptions included in the saving region 823 is “2” or more (S2705).

When it is determined that the number of receptions included in the saving region 823 is “2” or more, the erasing unit 807 subtracts “1 from the number of receptions included in the saving region 823 (S2707).

If it is determined however that the number of receptions included in the saving region 823 is not “2” or more, that is, that the number of receptions included in the saving region 823 is “1”, the erasing unit 807 releases the saving region 823 (S2709). That is, the data in the saving region 823 is erased.

The erasing unit 807 determines whether there is an unspecified SQL statement among the SQL statements included in the notification data received in S1601 in FIG. 16 (S2711). If it is determined that there is an unspecified SQL statement, the routine returns to S2701. If it is determined that there is no unspecified SQL statement, the erasing processing (B) is completed and the routine returns to 51601 in FIG. 16.

According to the present embodiment, the duplicate storage of an access plan corresponding to the same SQL statement can be avoided.

Moreover, in addition to erasing access plans in accompaniment to the release of connections in the primary system node 103, the available capacity of the storage region 821 in the subsystem node 107 can be recovered.

### Third Embodiment

When the available capacity of the storage region 631 is reduced in the database management system 121 of the primary system node 103, the access plans included in the cache region 633 may be erased. The following describes a case in which, when access plans in the database management system 121 of the primary system node 103 are erased in the present embodiment, the database management system 131 of the subsystem node 107 is synchronized and the access plans that are the same as the access plans erased in the database management system 121 of the primary system node 103 are erased.

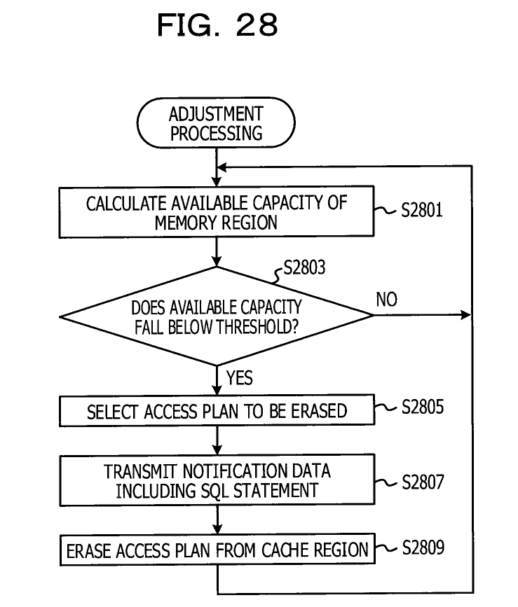

Next, adjustment processing by the adjusting unit 623 of the primary system processing unit 601 in the database management system 121 in the primary system node 103 will be explained. FIG. 28 illustrates an adjustment processing flow. The adjusting unit 623 calculates the available capacity of the storage region 631 at a predetermined timing (S2801). The adjusting unit 623 determines whether the available capacity of the storage region 631 is below a predetermined threshold (S2803). The predetermined threshold is a standard for recovering the available capacity of the storage region 631. If it is determined that the available capacity of the storage region 631 does not fall below the predetermined threshold, the routine returns to S2801.

Conversely, if it is determined that the available capacity of the storage region 631 falls below the predetermined threshold, the adjusting unit 623 selects an access plan to be erased (S2805). The adjusting unit 623 selects an access plan in which the last reference time period is old or selects an access plan in which the number of references is small. In this way, access plans that have a lower possibility of being used are erased first.

The notifying unit 621 refers to the cache region 633, specifies the SQL statement corresponding to the selected access plan, and transmits notification data including the specified SQL statement to the database management system 131 of the subsystem node 107 (S2807).

The adjusting unit 623 deletes the access plan selected in S2805 from the cache region 633 (S2809). At this time, the SQL statement corresponding to the access plan is also deleted from the cache region 633. The routine then returns to S2801.

The processing of the database management system 131 of the subsystem node 107 is the same as that in the second embodiment. That is, the notification data transmitted in S2807 in FIG. 28 is received in S1601 in FIG. 16. The erasing unit 807 executes the erasing processing (B) illustrated in FIG. 27 in S1609 in FIG. 16.

According to the present embodiment, in addition to erasing access plans for recovering the available capacity of the storage region 631 in the primary system node 103, the available capacity of the storage region 821 in the subsystem node 107 can also be recovered.

### Fourth Embodiment

An example releasing a connection with a primary system node 103 and erasing as a batch the access plans associated with the connection in a subsystem node 107, as in the first embodiment, along with not storing the access plan corresponding to the same SQL statement in the subsystem node 107, as in the second embodiment, is discussed in the present embodiment.

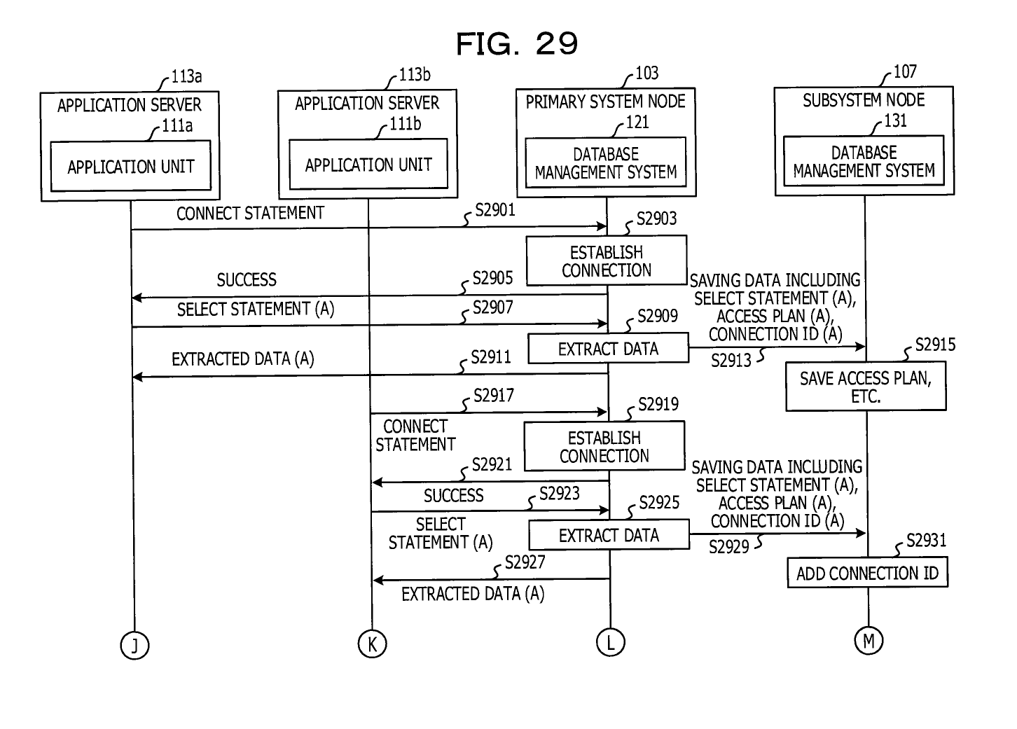

FIG. 29 illustrates an example of a sequence according to the fourth embodiment. In this example, it is assumed that a duplicate database system having the primary system node 103 and the subsystem node 107 is used for work by the application unit 111a in the application server 113a and for work by the application unit 111b in the application server 113b in the same way as in the second embodiment. Moreover, in this example a connection between the application unit 111a of the application server 113a and the database management system 121 of the primary system node 103 is present concurrently with a connection between the application unit 111b of the application server 113b and the database management system 121 of the primary system node 103.

An access request from the application unit 111a of the application server 113a to the database management system 121 of the primary system node 103, an access request from the application unit 111a of the application server 113a to the database management system 131 of the primary system node 107, an access request from the application unit 111b of the application server 113b to the database management system 121 of the primary system node 103, and an access request from the application unit 111b of the application server 113b to the database management system 131 of the subsystem node 107 are written for example in the format of a SQL statement in the same way as in the second embodiment. Access to the database may be requested using a question statement using a database language other than SQL. The sequence in this example is based on SQL specifications.

The application unit 111a of the application server 113a first transmits a CONNECT statement to the database management system 121 of the primary system node 103 (S2901).

Upon receiving the CONNECT statement, the database management system 121 of the primary system node 103 establishes a connection with the application unit 111a of the application server 113a that is the source of the request (S2903). At this time, a connection ID (A) for identifying the established connection is assigned. In this example, the connection ID (A) signifies a connection ID between the application unit 111a of the application server 113a and the database management system 121 of the primary system node 103. The database management system 121 of the primary system node 103 then returns a code indicating “success” to the application unit 111a of the application server 113a (S2905).

The application unit 111a of the application server 113a transmits a SELECT statement (A) to the database management system 121 of the primary system node 103 while the connection is established (S2907). The SELECT statement (A) assumes the connection established in S2903. The SELECT statement (A) signifies a SELECT statement of the type A in the same way as in the first and second embodiments.

The database management system 121 of the primary system node 103 receives the SELECT statement (A) and extracts data in accordance with the SELECT statement (A) (S2909). An access plan (A) based on the SELECT statement (A) is created at this time and the created access plan (A) is executed. As a result, the desired data is extracted from the designated records included in, for example, a designated table. The database management system 121 of the primary system node 103 temporarily stores the created access plan (A) in the cache region 633 inside the database management system 121 of the primary system node 103. The database management system 121 of the primary system node 103 then returns the extracted data (A) to the application unit 111a of the application server 113a (S2911). The data (A) signifies the data extracted based on the SELECT statement (A) in the same way as in the example in the first and second embodiments.

During the extraction of the data in S2909, the database management system 121 of the primary system node 103 creates saving data including the SELECT statement (A), the access plan (A), and the connection ID (A) and transmits the created saving data to the database management system 131 of the subsystem node 107 (S2913).

The database management system 131 of the subsystem node 107 receives the saving data and determines whether the access plan included in the saving data has been previously saved. In this example, the access plan (A) has not been saved yet, therefore the access plan and the data pertaining to the access plan included in the saving data are saved (S2915). The database management system 131 of the subsystem node 107 then stores “1” as the number of receptions of the access plan (A). In the fourth embodiment, the number of receptions of the access plan is incremented and the connection ID (A) is saved.

The application unit 111b of the application server 113b first transmits a CONNECT statement to the database management system 121 of the primary system node 103 in the same way as in the second embodiment (S2917).

Upon receiving the CONNECT statement, the database management system 121 of the primary system node 103 establishes a connection with the application unit 111b of the application server 113b that is the source of the request in the same way as in the second embodiment (S2919). At this time, connection ID (B) for identifying the established connections is assigned. In this example, the connection ID (B) signifies an ID of a connection between the application unit 111b of the application server 113b and the database management system 121 of the primary system node 103. The database management system 121 of the primary system node 103 then returns a code indicating “success” to the application unit 111b of the application server 113b (S2921).

Next, the application unit 111b of the application server 113b transmits the SELECT statement (A) to the database management system 121 of the primary system node 103 while the connection is established in the same way as in the second embodiment (S2923). The SELECT statement (A) assumes the connection established in S2919.

The database management system 121 of the primary system node 103 receives the SELECT statement (A) and extracts data in accordance with the SELECT statement (A) in the same way as in the second embodiment (S2925). An access plan (A) based on the SELECT statement (A) is created at this time and the created access plan (A) is executed. As a result, the desired data is extracted from the designated records included in, for example, the designated table. The database management system 121 of the primary system node 103 temporarily stores the created access plan (A) in the cache region 633 inside the database management system 121 of the primary system node 103. The database management system 121 of the primary system node 103 then returns the extracted data (A) to the application unit 111b of the application server 113b (S2927).

During the extraction of the data in S2925, the database management system 121 of the primary system node 103 creates saving data including the SELECT statement (A), the access plan (A), and the connection ID (B) and transmits the created saving data to the database management system 131 of the subsystem node 107 (S2929).

The database management system 131 of the subsystem node 107 receives the saving data and determines whether the access plan (A) included in the saving data has been previously saved in the same way as in S2915. In this example, the access plan (A) is previously saved and therefore the number of receptions of the access plan (A) is incremented to “2” and the connection ID (B) included in the saving data is additionally saved (S2931). In this way, when the database management system 131 of the subsystem node 107 determines that a previously received access plan has been received again using the SQL statement as a key regardless of different connections, the number of receptions is incremented and the connection ID is added. As a result, searching for the access plan can be performed using the connection ID as a key.

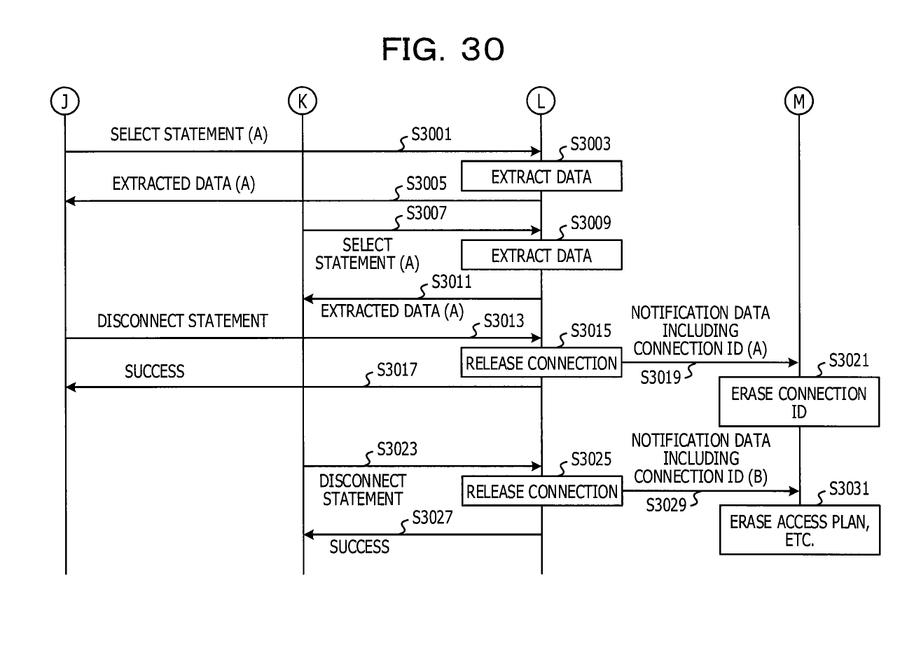

The sequence is continued in FIG. 30 through terminals J, K, L, and M. The sequence when the same SQL statement is received again is the same as the example in the first and second embodiments. The application unit 111a of the application server 113a retransmits the SELECT statement (A) to the database management system 121 of the primary system node 103 (S3001). The SELECT statement (A) transmitted in S3001 is the same as the SELECT statement (A) transmitted in S2907 and S2923 in FIG. 29. The retransmitted SELECT statement (A) assumes the connection established in S2903 in FIG. 29.

The database management system 121 of the primary system node 103 receives the SELECT statement (A) and extracts data in accordance with the SELECT statement (A) (S3003). The access plan (A) created in S2909 in FIG. 29 is read from the cache region 633 and the read access plan (A) is executed. That is, processing to create the access plan (A) based on the SELECT statement is omitted. The desired data is then extracted from the designated records included in, for example, the designated table. The database management system 121 of the primary system node 103 then returns the extracted data (A) to the application unit 111a of the application server 113a (S3005).

The application unit 111b of the application server 113b retransmits the SELECT statement (A) to the database management system 121 of the primary system node 103 (S3007). The SELECT statement (A) transmitted in S3007 is the same as the SELECT statement (A) transmitted in S2907, S2923 in FIG. 29 and in S3001 in FIG. 30. The retransmitted SELECT statement (A) assumes the connection established in S2919 in FIG. 29.

The database management system 121 of the primary system node 103 receives the SELECT statement (A) and extracts data in accordance with the SELECT statement (A) (S3009). The access plan (A) created in S2925 is read from the cache region 633 and the read access plan (A) is executed. Similarly, processing to create the access plan (A) based on the SELECT statement is omitted. The desired data is then extracted from the designated records included in, for example, a designated table. The database management system 121 of the primary system node 103 then returns the extracted data (A) to the application unit 111b of the application server 113b (S3011).

The application unit 111a of the application server 113a transmits a DISCONNECT statement to the database management system 121 of the primary system node 103 when the series of accesses assuming the connection is completed in the same way as in the second embodiment (S3013).

Upon receiving the DISCONNECT statement, the database management system 121 of the primary system node 103 releases the connection with the application unit 111a of the application server 113a that is the source of the request in the same way as in the second embodiment (S3015). At this time, the cache region 633 corresponding to the released connection is released. Therefore, the access plan based on the received SQL statement assuming the released connection is erased. In this example, the access plan (A) is erased. If a plurality of access plans based on the received SQL statement assuming the connection are present, the respective access plans are erased. The database management system 121 of the primary system node 103 then returns a code indicating “success” to the application unit 111a of the application server 113a (S3017).

Similar to the example in the first embodiment (S407 in FIG. 1), the database management system 121 of the primary system node 103 in the fourth embodiment transmits the notification data including the connection ID (A) that specifies the released connection to the database management system 131 of the subsystem node 107 (S3019).

The database management system 131 of the subsystem node 107 receives the notification data and searches for the access plan associated with the connection ID (A) included in the notification data among the access plans saved by the database management system 131. The respective access plans are specified if a plurality of access plans are associated with the connection ID included in the notification data. The database management system 131 of the subsystem node 107 then determines whether the number of receptions of the found access plans is “1” or “2”. If the number of receptions of the access plan is “2” or more, the database management system 131 of the subsystem node 107 decrements the number of receptions of the access plan. In this example, the “2” for the number of receptions of the access plan (A) found with the connection ID (A) is updated to “1”. The connection ID (A) is deleted. That is in conjunction with the reduction in the number of receptions, the connection ID is also deleted (S3021).

Next, the following discusses the case in which the number of receptions of the found access plan is “1”. The application unit 111b of the application server 113b transmits the DISCONNECT statement to the database management system 121 of the primary system node 103 when the series of accesses assuming the connection is completed in the same way as in the second embodiment (S3023).

Upon receiving the DISCONNECT statement, the database management system 121 of the primary system node 103 releases the connection with the application unit 111b of the application server 113b that is the source of the request (S3025). The data in the cache region 633 corresponding to the released connection is deleted and the cache region 633 is released in the same way as in S3015. In this example, the access plan (A) is erased. The database management system 121 of the primary system node 103 then returns a code indicating “success” to the application unit 111b of the application server 113b (S3027).

During the release of the connection indicated in S3025, the database management system 121 of the primary system node 103 transmits the notification data including the connection ID (B) that specifies the released connection to the database management system 131 of the subsystem node 107 (S3029).

The database management system 131 of the subsystem node 107 receives the notification data and searches for the access plan associated with the connection ID (B) included in the notification data among the access plans saved by the database management system 131. The database management system 131 of the subsystem node 107 then determines whether the number of receptions of the found access plans is “1” or “2”. When it is determined that the number of receptions of the access plan is “1”, the database management system 131 of the subsystem node 107 erases the access plan and the data pertaining to the access plan (S3031). In this example, the access plan (A) and the data pertaining to the access plan (A) are erased.

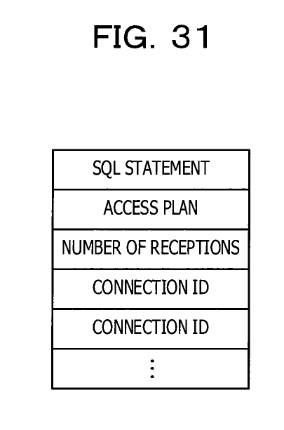

FIG. 31 illustrates an example of the saving region 823 according to the fourth embodiment. In the example in FIG. 31, a list of connection IDs is added to the example of the saving region 823 in the second embodiment illustrated in FIG. 23. The connection IDs included in the list specify connections when access plans are created. Therefore, the number of receptions matches the number of connection IDs included in the list. Therefore, a created access plan is extracted in the specification of a connection when searching for an access plan using a connection ID as a key.

Next, processing of the subsystem processing unit 801 in the database management system 131 according to the fourth embodiment will be explained. The main processing of the subsystem processing unit 801 is the same as illustrated in FIG. 16. The extraction processing will be discussed next as an example with regard to the features that are different from the first to third embodiments.

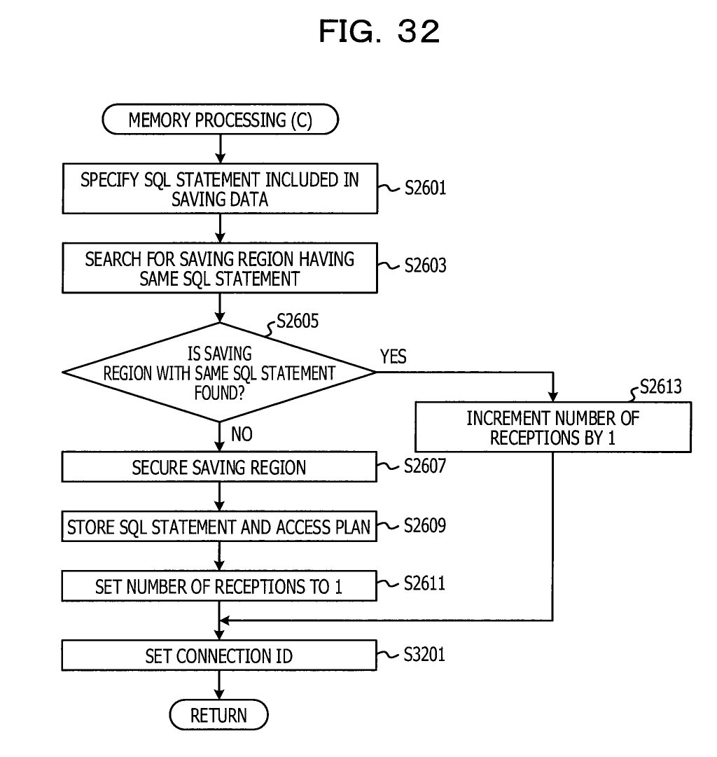

The memory processing unit 805 executes storage processing (C) in S1605 in FIG. 16 in place of the storage processing (A) illustrated in FIG. 17 and the storage processing (B) illustrated in FIG. 26. FIG. 32 illustrates the storage processing (C) flow. The processing from S2601 to S2613 is the same as the storage processing (B) in FIG. 26.

In the present embodiment, the memory processing unit 805 sets the connection ID included in the saving data received in S1601 in FIG. 16, in the saving region 823 secured in S2607 (S3201). If it is determined in S2605 that there is a saving region 823 having the SQL statement that is the same as the SQL statement specified in S2601, the connection ID included in the saving data received in 1601 in FIG. 16 is set in addition to the connection ID previously set in the saving region 823. The routine returns to S1601 in FIG. 16 when the storage processing (C) is completed.

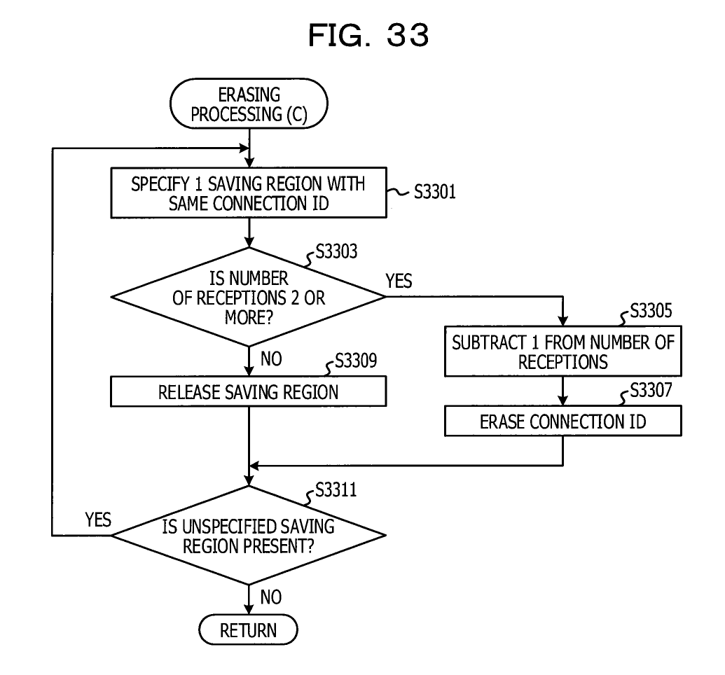

The erasing unit 807 executes erasing processing (C) in S1609 in FIG. 16 in place of the erasing processing (B) illustrated in FIG. 27. FIG. 33 illustrates the extraction processing (C) flow. The erasing unit 807 specifies one saving region 823 in which a connection ID that is the same as the connection ID included in the notification data received in S1601 in FIG. 16 is set in the header section (S3301). The erasing unit 807 then determines whether the number of receptions included in the saving region 823 is “2” or more (S3303).

When it is determined that the number of receptions included in the saving region 823 is “2” or more, the erasing unit 807 subtracts 1 from the number of receptions included in the saving region 823 (S3305). Furthermore, the erasing unit 807 deletes the connection ID included in the notification data received in S1601 in FIG. 16 from the saving region 823 (S3307).

If it is determined however in S3303 that the number of receptions included in the saving region 823 is not “2” or more, that is, that the number of receptions included in the saving region 823 is “1”, the erasing unit 807 releases the saving region 823 (S3309). That is, the data in the saving region 823 is erased.

The erasing unit 807 determines whether there is an unspecified saving region 823 among the saving regions 823 in which a connection ID that is the same as the connection ID included in the notification data received in S1601 in FIG. 16 is set in the header section (S3311). If it is determined that there is an unspecified saving region 823, the routine returns to S3301. Conversely, if it is determined that there is no unspecified saving region 823, the erasing processing (C) is completed and the routine returns to S1601 in FIG. 16.

According to the present embodiment, the duplicate storage of an access plan corresponding to the same SQL statement can be avoided.

A plurality of access plans can be erased as a batch using the connection ID.

### Fifth Embodiment

An example of changing to an access plan based on new statistics data in the subsystem node 107 in response to an update of the statistics data in the primary system node 103 will be explained in the present embodiment.

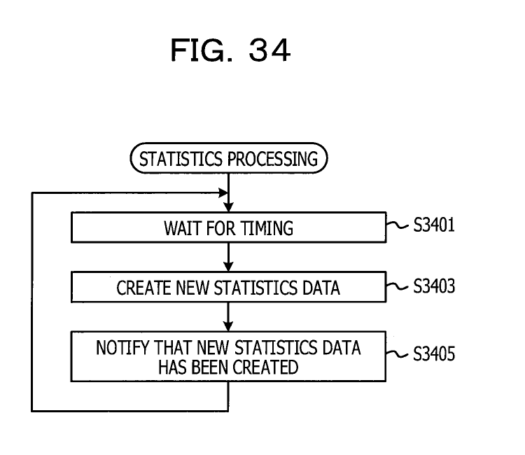

The following discusses statistics processing by the statistics unit 641 illustrated in FIG. 6. FIG. 34 illustrates a statistics processing flow. The statistics unit 641 waits for a predetermined timing (S3401) and creates new statistics data pertaining to the database (S3403).

The statistics unit 641 stores the new statistics data in the first data storing unit 643 at this time. The second data storing unit 833 included in the subsystem processing unit 801 of the database management system 131 is synchronized with the first data storing unit 643 via the first synchronization processing unit 645 included in the primary system processing unit 601 of the database management system 121 and the second synchronization processing unit 831 included in the subsystem processing unit 801 of the database management system 131. Therefore, when the new statistics data is stored in the first data storing unit 643, the same new statistics data is stored in the second data storing unit 833.

The statistics unit 641 notifies the database management system 131 of the subsystem node 107 that the new statistics data has been created (S3405). The routine then returns to S3401.

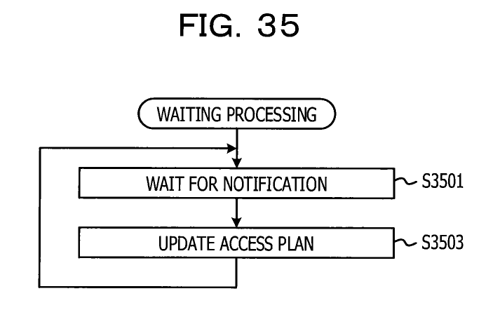

Next, processing of the database management system 131 according to the fifth embodiment will be explained. The updating unit 809 in the subsystem processing unit 801 executes standby processing. FIG. 35 illustrates a standby processing flow. The updating unit 809 waits for a notification that indicates that new statistics data has been created (S3501). Upon receiving the notification that the new statistics data has been created, the updating unit 809 updates the access plans stored in the saving regions 823 provided in the storage region 821 based on the new statistics data stored in the second data storing unit 833 (S3503). When the updating of the access plans is completed, the routine returns to S3501.

According to the present embodiment, an access plan based on the new statistics data in the subsystem node 107 can be changed in response to an update of the statistics data in the primary system node 103. Superior processing performance can be anticipated when an access plan is based on new statistics data in comparison to an access plan based on old statistics data.

While an embodiment of the present disclosure has been described as above, the present disclosure is not limited to this embodiment. For example, the above functional block configuration may not match the program module configuration.

The configurations of the storage regions described above are merely examples, and are not necessarily configured as described above. Moreover, the order of the processing flows may be altered so long as the processing results do not change. The processing flows may be conducted concurrently.

The primary system node 103 and the subsystem node 107 described above are computer devices and, as illustrated in FIG. 36, include a memory 2501, a central processing unit (CPU) 2503, a hard disk drive (HDD) 2505, a display controller 2507 connected to a display device 2509, a drive device 2513 for a removable disk 2511, an input device 2515, and a communication control unit 2517 for connecting to a network. All of the devices are connected to a bus 2519. An application program for implementing the processing of the present embodiment and an operating system (OS) is stored in the HDD 2505 and read from the HDD 2505 to the memory 2501 when executed by the CPU 2503. The CPU 2503 controls the display controller 2507, the communication control unit 2517, and the drive device 2513 in accordance with the processing contents of the application program to cause the devices to conduct certain operations. Data during processing is mostly stored in the memory 2501, but may also be stored in the HDD 2505. In the present embodiment, the application program for implementing the abovementioned processing is stored and distributed on the computer-readable removable disk 2511 and installed from the drive device 2513 to the HDD 2505. The application program may also be installed on the HDD 2505 through a network such as the Internet and the communication control unit 2517. This type of computer device implements the various functions described above due to the organic cooperation of hardware, such as the abovementioned CPU 2503 and the memory 2501, and programs such as the OS and the application program.

A summary of the embodiments described above is as follows.

The control method according to the present embodiment involves processing for receiving, from a primary system control device, access prescribing information for prescribing the execution contents of processing for accessing a database and an inquiry statement to the database corresponding to the access prescribing information, and storing the same in a storage unit, in a subsystem control device that is a standby system of the primary system control device for controlling access to the database, and when a notification is received for releasing a connection, between the primary system control device and a terminal device for accessing the database via the primary system control device, of the access based on the inquiry statement, the access prescribing information stored in the storage unit and corresponding to the released connection is erased.

In this way, the depletion of storage regions for storing access prescribing information in a subsystem control device can be averted.

The control method counts the number of receptions of the access prescribing information corresponding to the same inquiry statement from the primary system control device, and may not store the access prescribing information if the number is two or greater.

Accordingly, duplicate storing of the access prescribing information corresponding to the same inquiry statement can be avoided.

When the primary system control device notifies that the access prescribing information in the storage unit of the primary system control device has been erased, the control method may involve processing to erase the access prescribing information notified as erased that is stored in the storage unit of the subsystem control device.

As a result, the available capacity of the storage regions in the subsystem control device can be recovered in conjunction with the erasing of the access prescribing information in the primary system control device.

When the primary system control device notifies that statistics data pertaining to the database has been updated, the control method may involve processing to update the access prescribing information stored in the storage unit based on the updated statistics data and data stored in the database corresponding to the updated statistics data.

As a result, the access prescribing information based on the new statistics data can be changed in response to an update of the statistics data in the primary system control device.

The control method according to the present embodiment is a control method of a database system provided with a primary system control device and a subsystem control device, wherein (A) the primary system control device transmits, to the subsystem control device, created access prescribing information and an inquiry statement to the database corresponding to the access prescribing information in response to the creation of the access prescribing information for prescribing the execution contents of processing for accessing the database; and notifies the subsystem terminal device about a release of a connection in response to the release of the connection for accessing based on the inquiry statement, the connection being between the primary system control device and a terminal device for accessing the database via the primary system control device; and (B) the subsystem control device stores the access prescribing information transmitted from the primary system control device in a storage unit, and when a notification is received for releasing a connection from the primary system control device, erases the access prescribing information corresponding to the released connection stored in the storage unit.

In this way, the depletion of storage regions for storing access prescribing information in a subsystem control device can be averted.

Programs may be made to cause a computer to conduct processing according to the above methods. The programs may be stored in a computer-readable storage medium or a storage device such as, for example, a flexible disk, a CD-ROM, an optical magnetic disc, a semiconductor memory, a hard disk and the like. Intermediate processing results are temporarily stored in a storage device such as a main memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A system comprising:
a primary control device configured to control access to a first database; and
a secondary control device which is a standby device of the primary control device and is configured to control access to a second database, wherein
the secondary control device is configured to:
receive first access prescribing information which prescribes processing for accessing the first database, and an inquiry statement to the first database from the primary control device, the inquiry statement corresponding to the first access prescribing information;
store the received first access prescribing information as a second access prescribing information and the inquiry statement in a first memory of the secondary control device; and
erase the second access prescribing information, which is stored in the first memory and is used for the secondary control device to access the second database based on the inquiry statement, when a notification of releasing a connection is received from the primary control device, the connection being between the primary control device and a device for accessing the first database through the primary control device.

2. The system according to claim 1, wherein
the secondary control device is further configured to:
count a number of times the first access prescribing information corresponding to a same inquiry statement is received from the primary control device; and
prevent from storing the received first access prescribing information and the inquiry statement in the first memory when the counted number of times is two or greater.

3. The system according to claim 1, wherein
the secondary control device is further configured to:
erase the second access prescribing information stored from the first memory when a notification indicating that first access prescribing information stored in a second memory in the primary control device is erased, is received from the primary control device, the second access prescribing information to be erased corresponding to the first access prescribing information stored in the second memory.

4. The system according to claim 1, wherein
the secondary control device is further configured to:
when a notification indicating an update of statistics data pertaining to the first database is received from the primary control device, update the second access prescribing information stored in the first memory based on the update of statistics data and data stored in the second database corresponding to the updated statistics data.

5. A method executed by a secondary control device that is a standby system of a primary control device which controls access to a first database, the secondary control device controlling access to a second database, wherein the method comprises:
receiving first access prescribing information which prescribes processing for accessing the first database, and an inquiry statement to the first database from the primary control device, the inquiry statement corresponding to the first access prescribing information;
storing the received first access prescribing information as a second access prescribing information and the inquiry statement in a first memory of the secondary control device; and
erasing the second access prescribing information, which is stored in the first memory and is used for the secondary control device to access the second database based on the inquiry statement, when a notification of releasing a connection is received from the primary control device, the connection being between the primary control device and a device for accessing the first database through the primary control device.

6. The method according to claim 5, further comprising:
counting a number of times the first access prescribing information corresponding to a same inquiry statement is received from the primary control device; and
preventing from storing the first received access prescribing information and the inquiry statement in the first memory when the counted number of times is two or greater.

7. The method according to claim 5, further comprising:
erasing the second access prescribing information stored from the first memory when a notification indicating that first access prescribing information stored in a second memory of the primary control device is erased, is received from the primary control device, the second access prescribing information to be erased corresponding to the first access prescribing information stored in the second memory.

8. The method according to claim 5, further comprising:
when a notification indicating an update of statistics data pertaining to the first database is received from the primary control device, updating the second access prescribing information stored in the first memory based on the update of statistics data and data stored in the second database corresponding to the updated statistics data.

9. A non-transitory computer readable recording medium having stored therein a program that causes a secondary control device, that is a standby device of a primary control device which controls access to a first database, the secondary control device controlling access to a second database, to execute a process, the process comprising:
receiving first access prescribing information which prescribes processing for accessing the first database, and an inquiry statement to the first database from the primary control device, the inquiry statement corresponding to the first access prescribing information;
storing the received first access prescribing information as a second access prescribing information and the inquiry statement in a first memory of the secondary control device; and
erasing the second access prescribing information, which is stored in the first memory and is used for the secondary control device to access the second database based on the inquiry statement, when a notification of releasing a connection is received from the primary control device, the connection being between the primary control device and a device for accessing the first database through the primary control device.

10. The recording medium according to claim 9, further comprising:
counting a number of times the first access prescribing information corresponding to a same inquiry statement is received from the primary control device; and
preventing from storing the first received access prescribing information and the inquiry statement in the first memory when the counted number of times is two or greater.

11. The recording medium according to claim 9, further comprising:
erasing the second access prescribing information stored from the first memory when a notification indicating that first access prescribing information stored in a second memory of the primary control device is erased, is received from the primary control device, the second access prescribing information to be erased corresponding to the first access prescribing information stored in the second memory.

12. The recording medium according to claim 9, further comprising:
when a notification indicating an update of statistics data pertaining to the first database is received from the primary control device, updating the second access prescribing information stored in the first memory based on the update of statistics data and data stored in the second database corresponding to the updated statistics data.
